(19) United States
(12) Patent Application Publication
(10) Pub. No.: US 2010/0039912 A1
(43) Pub. Date: Feb. 18, 2010

(54) OPTICAL INFORMATION RECORDING/REPRODUCING UNIT AND METHOD OF MEASURING RECORDED-MARK QUALITY

(76) Inventors: Masaki Nakano, Tokyo (JP); Masatsugu Ogawa, Tokyo (JP); Masaru Nakamura, Tokyo (JP)

Correspondence Address: Mr. Jackson Chen, 6535 N. STATE HWY 161, IRVING, TX, 75039, US

(21) Appl. No.: 12/439,894

(22) PCT Filed: Sep. 11, 2007
(86) PCT No.: PCT/JP2007/067648

§ 371 Date: Mar. 4, 2009

(30) Foreign Application Priority Data
Sep. 11, 2006 (JP) 2006-245236

(51) Int. Cl. G11B 27/36

(52) U.S. Cl. 369/53.11; 369/59.22; G9B/27.052

(57) ABSTRACT

An equalizer (22) performs a PR equalization of a reproduced signal waveform output from an A/D converter (21). A reference-waveform generation unit (42) generates a reference reproduced-waveform based on a recording data train estimated from the reproduced signal waveform by a recognition unit (30). An equalization-error calculation unit (43) calculates an equalization error between the reference reproduced-waveform and the reproduced signal waveform. A transient equalization-error detector (44) extracts equalization error information, as a transient equalization error, at the time instant at which the reference reproduced-waveform assumes a specific level, and at which the specific level-value and a level-value of the reference reproduced-waveform at one channel clock before or after the time instant satisfy therebetween a specific relative relationship. The extracted transient equalization error is used as an index showing the quality of the recorded mark.

### TECHNICAL FIELD

The present invention relates to an optical information recording/reproducing unit, a method of measuring a recorded-mark quality, and a record control method and, more particularly, to an optical information recording/reproducing unit that irradiates a laser beam onto an optical information recording medium, to perform data recording and data reproduction, as well as a method of measuring a recorded-mark quality and a record control method used in such an optical information recording/reproducing unit.

### BACKGROUND ART

In the field of data storage, the data volume to be treated is ever increasing together with the diversification of information, etc. In the optical disc, effort of increasing the memory capacity has been continued from CDs to DVDs by increasing the memory density. For the effort of technical development toward the higher density, there have been developed a technique of accurately recording marks with a size as small as possible, a technique of accurately reproducing data even below the vicinity of limit of optical reproduction. Hereinafter, these techniques will be described with reference to recordable DVDs.

As the recordable DVDs, optical discs such as DVD-RAM, DVD-R, DVD-RW, DVD+R, and DVD+RW, have appeared on the market. Some optical disc drives that perform recording/reproducing on the recordable optical discs have a recording speed as high as up to a 16× speed. Generally, the recordable optical disc has an area (PCA: power calibration area) in a part of the disc area for calibrating therein the recording power, and the optical disc drive uses this area to perform control of the optical power (OPC: optimum power control) at a suitable timing. The optical disc drive, upon the data recording, performs recording using the power obtained by the recording power calibration. Known examples of the recording power calibration include a beta technique that obtains a beta (β) value by inspecting asymmetry from the reproduced amplitude of a long mark and the reproduced amplitude of a short mark, a gamma technique that judges a state from the degree of amplitude saturation of a recorded mark, etc.

As to the recording-laser-pulse waveform (laser-emitted waveform during the recording), referred to as recording strategy, is selected based on the information provided beforehand on the disc, and/or information stored in the optical disc drive depending on the specification and type of the optical disc medium. FIG. 34 illustrates the recording waveform used for forming a recorded mark. Types of the recording waveform include a non-multiple-pulse type that irradiates a single pulse for forming a recorded mark, and a multiple-pulse type that irradiates two or more pulses for forming a recorded mark. FIGS. 34(b) and 34(c) show the non-multiple-pulse waveform, wherein the pulse width is controlled corresponding to the mark length of the mark of FIG. 34(a) to be recorded. In FIG. 34(b), a compensation waveform is added on the record-starting front edge and the rear edge. FIG. 34(d) shows a multiple-pulse waveform which is irradiated as a plurality of pulses depending on the mark length.

As the techniques for calibration of the recording waveform, there are techniques described in, for example, Patent Publications-1 to -3. Patent Publication-1 uses a technique of optimizing the recording pulse without being affected by the skill etc. of the engineer, by iterating a combination of test recording while changing the pulse setting and measuring of the jitter obtained by detecting the signal reproduced therefrom to thereby optimize the recording pulse. Patent Publication-2 performs correction of the time width of the recording waveform based on the error between the data width of the reproduced signal reproduced from the recorded data and the reference data width. Patent Publication-2 describes that the recording accuracy can be improved by using a specific pattern in this process. Patent Publication-3 discloses a technique of detecting the edge interval of the recorded mark or space (duty ratio of mark or space) and the change of recording condition, to adjust the edge position of the recording pulse. These techniques obtain the error of the reproduced signal with respect to the reference, i.e., a deviated amount along the time axis (such as jitter or time interval) after directly converting the reproduced signal into pulses.

Next, a reproduction technique will be described. Conventionally, binarization of data used a slice-discrimination technique. This technique uses an equalizer that performs filtering of the reproduced waveform so as to reduce the intersymbol interference. In this case, since the equalizer increases the noise component while suppressing the intersymbol interference, it is difficult to decode the recorded original data from the reproduced signal if a higher-density-recording is used. On the other hand, there is a partial-response maximum likelihood (PRML) technique, as a technique effective to accurately decode the data recorded with a higher density. In this technique, the reproduced waveform is subjected to partial-response (referred also to as PR hereinafter) equalization to be converted into a waveform having an intersymbol interference, and then to a data discrimination using a technique known as Viterbi decoding (ML). The PR equalization is specific by the amplitude of each data period (clock), and PR(abc), for example, is such that the amplitude at time instant 0 is “a”, amplitude at time instant T is “b”, the amplitude at time instant 2T is “c”, and the amplitude at other time instants is zero. The total number of components having an amplitude not zero is referred to as restricted length. For improvement of the density, it is effective to use a partial-response waveform having a longer restricted length. This conversely means the assumption that “a longer restriction-length waveform corresponds to a waveform having a larger intersymbol interference.”

As an example, a PR(1,2,2,2,1) characteristic will be described. The PR(1,2,2,2,1) characteristic means the characteristic wherein the reproduced signal corresponding to binary bit “1” assumes “12221”, and computation of convolution between the binary bit series and series “12221” showing the PR characteristic provides a reproduced signal. For example, the reproduced signal calculated from a binary bit series “0100000000” assumes “0122210000.” Similarly, the reproduced signal calculated from a binary bit series “0110000000” assumes “0134431000” the reproduced signal calculated from a binary bit series “011100000” assumes “0135653100”, the reproduced signal calculated from a binary bit series “0111100000” assumes “0135775310”, and the reproduced signal calculated from “0111110000” assumes “0135787531.” Such a reproduced signal calculated by the calculation of convolution is an ideal reproduced signal (path).

The reproduced signal assumes nine levels in the PR(1,2,2,2,1) characteristic. However, the actual reproduced signal does not necessarily have the PR(1,2,2,2,1) characteristic, and includes a degradation factor, such as noise. In the PRML detection, the reproduced signal is rendered close to the PR characteristic by using the equalizer. The reproduced signal rendered close to the PR characteristic is referred to as an equalized reproduced signal. Thereafter, a discriminator (such as Viterbi decoder) is used to select a path having a smallest Euclid distance with respect to the equalized reproduced signal. The path and binary bit series have therebetween a 1:1 relationship. The Viterbi decoder that performs Viterbi decoding operation outputs the binary bit series corresponding to the selected path, as the decoded binary data. A system using the PRML premises that the reproduced signal has three- or more-value data, i.e., multiple-value data instead of the binary data. The slice-discrimination detection technique judges presence or absence of the pit by using a suitable slicing, and then uses binary equalization for the data reproduction. On the other hand, the PRML detection premising the multiple-value data requires a recording/reproducing waveform that is suitable for the PRML detection, unlike the slice-discrimination detection.

FIG. 35 shows an example of measurement of the error rate by using the binary equalization in the conventional slice-discrimination technique and by using the PRML detection technique, both for the case where the pit length is changed. In FIG. 35, the error rate is plotted on ordinate, whereas the minimum pit length is plotted on abscissa. The minimum pit length is defined by the laser wavelength, λ, of the light source and the numerical aperture, NA, of the objective lens. Graph (a) represents the error rate incurred in by PRML detection, graph (b) represents the error rate incurred in the slice-discrimination, and the one-dot-chain line represents the rough standard of the error rate that is permissible in the drive. With reference to graph (b), the slice-discrimination has a limit of around 0.35×λ/NA. On the other hand, in the PRML detection shown by graph (a), the error rate underruns the allowable value for a smaller pit length, whereby it is understood that the PRML detection can reproduce a smaller pit as compared to the slice-discrimination. In the conventional DVD, the pit length is around 0.37×λ/NA.

The inventors of the present invention disclose, in Patent Publication-4, means for detecting an item corresponding to the amplitude or asymmetry in the case of using the PRML detection. In this publication, an asymmetry detection circuit includes a timing adjustment circuit that receives a digitized sampled value, a Viterbi detector that receives the sampled value, a reference-level judgment unit that receives the output of the Viterbi detector, a filter circuit that receives the output of the Viterbi detector, an error calculation unit that calculates a difference between the output of the filter and the output of the timing adjustment circuit, a plurality of discrimination circuits that discriminate the output of the error detection circuit by using the output of the reference-level judgment unit as a discriminating signal, a plurality of integration circuits that integrate the output of the plurality of discrimination circuits, and an average calculation circuit that calculates the average of the maximum integrated reference level and the minimum integrated reference level selected from among the outputs of the integration circuits, and executes a calculation operation that calculates the difference between the median integrated reference level corresponding to the central level of the plurality integrated reference values and the above average.

A system is practically used that applies the technique of PRML (partial-response maximum-likelihood) technique onto an optical disc having a higher recording density than the DVD. Non-Patent-Document-1 reports that it is possible to calibrate the recording power by using the PRSNR as the SNR (signal-to-noise ratio) of the PR system in such a system. Non-Patent-Document-2 reports the PRSNR.

### List of Documents:

Patent Publication-1 (JP-2005-216347A);

Patent Publication-2 (JP-2002-230770A);

Patent Publication-3 (JP-1993-135363A);

Patent Publication-4 (JP-2002-197660A);

Non-Patent-Document-1 (Jpn. J. Appl. Phys., Vol. 43, No. 7B (2004), “Optimization-of-Write-Conditions-with-a New Measure in High-Density-Optical-Recording”, M. Ogawa et al.; and

Non-Patent-Document-2 (ISOM2003 (International Symposium Optical Memory 2003), Technical Digest pp. 164-165 “Signal-to-Noise Ratio in a PRML Detection” S. OHKUBO et al.

In the conventional calibration of the recording condition, the quality of signal recorded at a recording density comparable to that of the DVD and CD is obtained by using a deviation of the reproduced signal, which is directly binarized as by level-slicing the reproduced signal, with respect to the reference level, detecting the deviated amount of the jitter, time interval etc. in the time axis direction, and optimizing the recording power and recording waveform by performing correction based on these values. On the other hand, for a signal recorded at a higher density up to the degree of allowing use of the PRML detection technique, a level slice detection cannot be applied to a short mark, and is unable to directly measure the signal deviation in the view point of the accuracy, unlike to the conventional technique. Thus, the recording quality of the signal recorded at a higher recording density is obtained by optimization of the recording power and recording waveform by using the PRSNR, error rate, and/or asymmetry correlated with these values.

In the optimization of recording condition, a large number of parameters are optimized to determine the optimum condition. However, the optimization of recording condition may in fact encounter locally-optimized parameters, even if an apparently suitable result is obtained. For example, even if the recording waveforms (time widths) are the same in the time direction with respect to the recording compensation setting in a specific pattern during the recording, there may be a difference therebetween in the power margin for the same power and the same performance if the recording start positions of the recording waveforms are different.

In the conventional techniques, there is no known technique that is capable of easily confirming whether or not the recorded signal that is recorded after optimizing the large number of parameters is optimum to the PRML detection technique, especially including the view point of margin. Thus, there arise the problem that, upon determining the recording power based on the performance index, a locally-optimized condition may be determined as the optimum recording condition if it is found optimum in the local condition, although there may exist in fact a recording condition that achieves a wider power margin.

FIG. 36 shows the relationship between the recording power and the PRSNR. An optical head that has a NA (numerical aperture) of 0.65 for the objective lens and a LD wavelength, λ, of 405 nm was used to record a 2T mark that is a shortest mark onto a write-once disc having a diameter of 120 mm, a substrate thickness of 0.6 mm and a track pitch of 0.4 μm, by using a (1,7) RLL and a minimum bit length of 0.153 μm/bit while changing the recording power between conditions (condition-1 and condition-2) including different recording positions. Measurement of the PRSNR therefrom revealed the results represented by graphs (a) and (b) in FIG. 36. The PRSNR is an evaluation index that is adopted in the HD DVD family, i.e., a signal-quality evaluation index that replaces the jitter conventionally used, and is the SNR (signal-to-noise ratio) in the PRML. It can be concluded that a higher PRSNR means a higher signal quality.

With reference to FIG. 36, if the power ratio is “1” (standard power), the PRSNR is around 33 for both the condition-1 (graph (a)) and condition-2 (graph (b)), whereby it is concluded that the signal quality is comparable. However, for the condition-2, the PRSNR, i.e., the signal quality is degraded when the power ratio exceeds 1. On the other hand, for the condition-1, when the power ratio exceeds 1, the signal quality maintains a PRSNR comparable to that when the power ratio is 1, and thus it is understood that the condition-1 has a wider margin than the condition-2. In this case, there is no significant difference in the PRSNR at the power ratio of 1 between the condition-1 and the condition-2, and accordingly, the condition-2 that is locally optimum may be selected as the suitable parameter at the power ratio of 1. When the margin of other variety of parameters is taken into consideration, a margin that is as wide as possible is desired. However, if the condition-2 is adopted as the parameter, the margin of other parameters will be suppressed.

For the above problem of local optimality, it may be considered to measure the margin for all the parameter conditions, and select the condition therefrom; however, this requires a larger time length for obtaining the optimum solution, and consumes a larger area. In addition, if the optical heads have a significant range of variation therebetween in the performance thereof, determination of the condition by using a specific optical head after a long-time operation thereof cannot necessarily provide the optimum condition for a number of drives, if such drives are manufactured in a mass production. In this case, there arises the problem that the drives manufactured in the mass production suffer from a lower product yield, as a result of poor adaptability.

### SUMMARY OF THE INVENTION

It is an object of the present invention to solve the above problems of the conventional techniques and to provide a method of measuring the quality of recorded mark in an optical information recording/reproducing unit, which is capable of detecting with a higher degree of accuracy the deviation of the position at which the recorded mark is formed by a high-density recording, and the optical information recording/reproducing unit that uses the method.

The present invention provides an optical information recording/reproducing unit including: a reproducing section (10) that reads out a mark and a space recorded on an optical information recording medium to generate a reproduced signal waveform; a reference-waveform generation section that generates a reference reproduced-waveform obtained by applying a specific response characteristic to a data train corresponding to the reproduced signal waveform; a transient-equalization-error calculation section that calculates, as a transient equalization error, a difference between the reference reproduced-waveform and the reproduced signal waveform at a time instant at which the reference reproduced-waveform assumes a specific level-value and at which the specific level-value and a level-value group at m channel clocks (m is an integer not less than one) before or after the time instant of the specific level-value satisfy therebetween a specific relationship.

The present invention provides a method for measuring a recorded-mark quality of an optical information recording medium, that finds the recorded mark quality from a reproduced signal that is read from a mark and a space recorded on the optical information recording medium, the method including: generating a reproduced signal waveform from the recorded mark and space; generating a reference reproduced-waveform obtained by applying a specific response characteristic to a data train corresponding to the reproduced signal waveform; calculating, as a transient equalization error, a difference between the reference reproduced-waveform and the reproduced signal waveform at a time instant at which the reference reproduced-waveform assumes a specific level-value and at which the specific level-value and a level-value group at m channel clocks (m is an integer not less than one) before or after the time instant satisfy therebetween a specific relationship.

The present invention provides a record controlling method for an optical information recording medium in an optical information recording/reproducing unit, including: generating a reproduced signal waveform from a recorded mark and space recorded on the optical information recording medium; generating a reference reproduced-waveform obtained by applying a specific response characteristic to a data train corresponding to the reproduced signal waveform; calculating, as a transient equalization error, a difference between the reference reproduced-waveform and the reproduced signal waveform at a time instant at which the reference reproduced-waveform assumes a specific level-value and at which the specific level-value and a level-value group at m channel clocks (m is an integer not less than one) before or after the time instant satisfy therebetween a specific relationship; and controlling a shape of a recording laser pulse that irradiates the optical information recording medium upon data recording so that the transient equalization error decreases.

The above and other objects, features and advantages of the present invention will be more apparent from the following description, referring to the accompanying drawings.

### BRIEF DESCRIPTION OF THE DRAWINGS

FIG. 1 is a block diagram showing the configuration of an optical information recording/reproducing unit according to a first exemplary embodiment of the present invention.

FIG. 2 is a block diagram showing the configuration of the optical head.

FIG. 3 is a block diagram showing the configuration of the signal-quality detector in the first exemplary embodiment.

FIG. 4 is a block diagram showing the configuration of an optical information recording/reproducing unit according to a modification of the first exemplary embodiment.

FIG. 5 is a block diagram showing the configuration of a signal-quality detector in a modification of the first exemplary embodiment.

FIG. 6A is a waveform diagram showing the reproduced eye-pattern waveform, and FIG. 6B is a state transition diagram showing the way of change of signal.

FIG. 7 is a waveform diagram showing the reference reproduced-waveform for the 2T-6T.

FIG. 8 is a flowchart showing the processing flow of quality measurement of the recorded mark in the optical information recording/reproducing unit of the first exemplary embodiment.

FIG. 9 is a block diagram showing the configuration of the signal-quality detector provided in the optical information recording/reproducing unit according to a second exemplary embodiment.

FIG. 10 is a flowchart showing the processing flow of quality measurement of the recorded mark in the optical information recording/reproducing unit of the second exemplary embodiment.

FIG. 11 is a block diagram showing the configuration of the signal-quality detector provided in the optical information recording/reproducing unit according to a third exemplary embodiment.

FIG. 12 is a graph showing the transient equalization error corresponding to a 2T mark while classifying the same based on the space length ahead and behind the 2T mark.

FIG. 13 is a flowchart showing the processing flow of quality measurement of the recorded mark in the optical information recording/reproducing unit of the third exemplary embodiment.

FIGS. 14A and 14B are a graph showing the result of plotting the equalization error of the mark or space in the condition- 1 and condition-2.

FIG. 15 is a graph showing the relationship between the 2Tsfp and the transient equalization error corresponding to the 2T pattern.

FIG. 16 is a graph showing the relationship between the 2Tsfp and the transient equalization error corresponding to the 2T pattern.

FIG. 17 is a graph showing the transient equalization error corresponding to the front edge and rear edge of the 2T, 3T, and 4T or longer patterns.

FIG. 18 is a graph showing the transient equalization error corresponding to the front edge and rear edge 2T, 3T, and 4T or longer patterns.

FIG. 19 is a graph showing the result of measuring the transient equalization error of each pattern in the respective recording conditions.

FIG. 20 is a graph showing the result of measuring the PRSNR in each recording condition.

FIG. 21 is a graph showing the result of measuring the PRSNR in the respective recording conditions.

FIG. 22 is a graph showing the results of measuring the transient equalization error of each pattern.

FIG. 23 is a graph showing the correspondence relationship between the tilt and the PRSNR.

FIG. 24 is a graph showing the relationship between the recording power and the transient equalization error and PRSNR corresponding to the 2T pattern.

FIG. 25 is a graph showing the relationship between the power ratio and the transient equalization error (after calculation) that is the difference between the front edge and the rear edge and corresponding to 2T and PRSNR.

FIGS. 26A to 26E are a graph showing the transient equalization error of the respective calibration conditions upon measurement of the transient equalization error while adaptively changing the recording condition (calibration condition of pulse waveform).

FIG. 27 is a graph showing the relationship between the power and the transient equalization error (after calculation) that is the difference between the front edge and the rear edge of a 2T mark.

FIG. 28 is a graph showing the results of measuring the transient equalization error with respect to a 2T mark.

FIG. 29 is a graph showing the results of measuring the transient equalization error with respect to a 2T mark.

FIG. 30 is a state transition diagram showing the way of transition in the PR1221.

FIG. 31 is a waveform diagram showing the reference reproduced-waveform of 2T to 5T in the PR1221.

FIG. 32 is a waveform diagram showing the situation of the level-value change of the reference reproduced-waveform in the PR12221.

FIG. 33 is a waveform diagram showing the situation of the reference reproduced-waveform level-value change in PR1221.

FIG. 34 is a waveform diagram showing a recording waveform.

FIG. 35 is a graph showing the relationship between the pit length and the error rate.

FIG. 36 is a graph showing the relationship between the recording power and the PRSNR.

### BEST MODE OF CARRYING OUT THE INVENTION

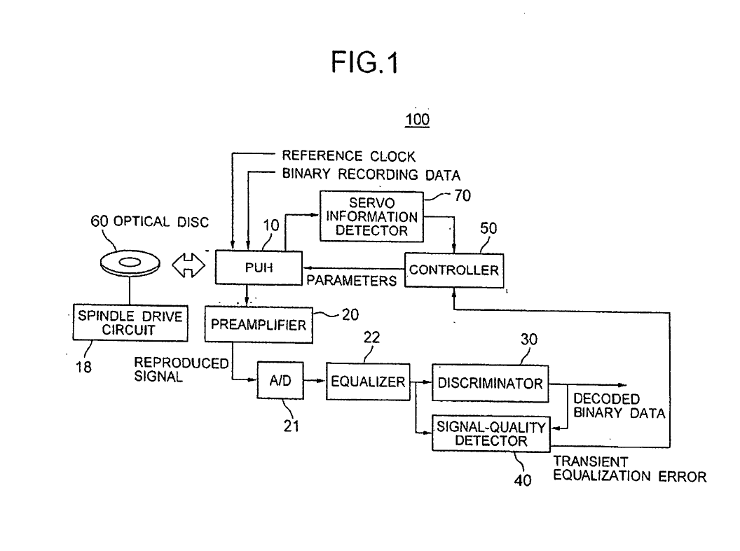

Hereinafter, exemplary embodiments of the present invention will be described in detail with reference to the drawings. FIG. 1 shows the configuration of an optical information recording/reproducing unit according to a first exemplary embodiment of the present invention. The optical information recording/reproducing unit 100 includes a PUH (pick-up head: optical head) 10, a spindle drive circuit 18, a preamplifier 20, an A/D converter 21, an equalizer 22, a discriminator 30, a signal-quality detector 40, a controller 50, and a servo information detector 70. The optical information recording/reproducing unit 100 performs information recording onto an optical disc 60, and information reproduction from the optical disc 60.

The controller 50 controls the drive for the overall operation thereof. The PUH 10 configures a reproducing section in the present invention, and irradiates a laser beam onto the optical disc 60 to receive the reflected light thereof. The servo information detector 70 generates a signal for servo-driving the PUH 10 based on the information from the PUH 10. In the servo technique, the PUH 10 itself or the objective lens 11 of the PUH 10 is finely or roughly controlled for positioning-control thereof in the radial direction of the optical disc 60, and in the direction perpendicular to the recording surface of the optical disc 60. In addition, based on the tilt detected between the optical disc 60 and the PUH 10, the tilt is controlled for correction thereof. These units have their own parameters.

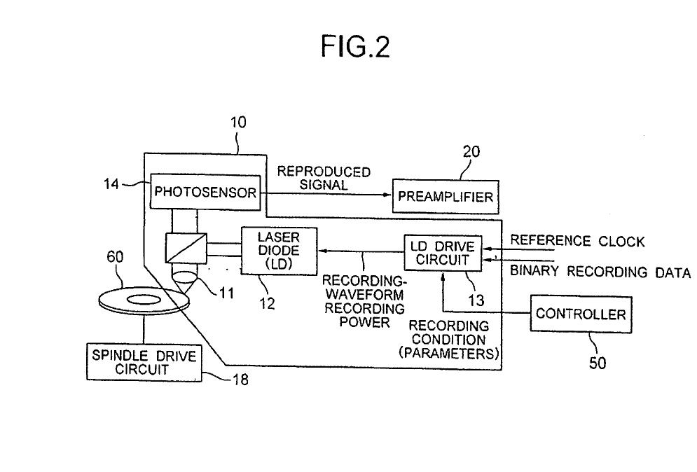

FIG. 2 shows the configuration of PUH 10. The PUH 10 includes an objective lens 11, a laser diode (LD) 12, a LD drive circuit 13, and an photosensor 14. PUH 10 includes an objective lens 11, a laser diode (LD) 12, a LD drive circuit 13, and an photosensor 14. The LD 12 outputs the laser beam having a specific wavelength. The LD drive circuit 13 controls the output of LD 12. The objective lens 11 irradiates the laser beam output from the LD 12 onto the recording surface of the optical disc 60. The objective lens 11 receives the reflected light corresponding to the irradiated laser beam from the optical disc 60, and supplies the reflected light onto the photosensor 14. The photosensor 14 reproduces the data recorded on the optical disc based on the reflected light from the optical disc 60.

Upon recording onto the optical disc 60, binary recording data is input to the LD drive circuit 13. The binary recording data has been converted by a modulator not shown into a series of data wherein the minimum run length assumes “1”, i.e., “0” or “1” in the binary bit series continues at least two in number. The binary recording data is converted into a recording waveform by the LD drive circuit 13 in accordance with the recording condition (parameters) output from the controller 50. The recording waveform of the electric signal is converted into an optical signal in the optical head, and irradiated onto the optical disc from the LD 12. Recorded marks are formed on the optical disc 60 in accordance with the irradiation of laser.

The spindle drive circuit 18 rotates the optical disc 60 upon recording and reproduction. An optical disc attached with a guide groove is used as the optical disc 60. The controller 50 iterates the judgment of whether or not a record-interrupt condition defined beforehand is satisfied after the recording is started. The controller 50 interrupts the recording, upon judging that the record-interrupt condition is satisfied, and then performs reproduction of the recorded area including the area in which the record is interrupted.

Back to FIG. 1, the preamplifier 20 amplifies the reproduced faint signal output from the photosensor 14 (FIG. 2). The amplified reproduced signal is converted into a digital signal by sampling at a constant frequency by the A/D converter 21. The equalizer 22 includes a PLL circuit, converts the digitized reproduced signal into a signal synchronized with the channel clock, and at the same time, into the equalized reproduced signal close to the PR(1,2,2,2,1) characteristic, for example. Typically, the discriminator 30 is configured as a Viterbi detector, selects a path having a smallest Euclid distance with respect to the equalized reproduced signal, and outputs the binary bit series corresponding to the selected path as the decoded binary data.

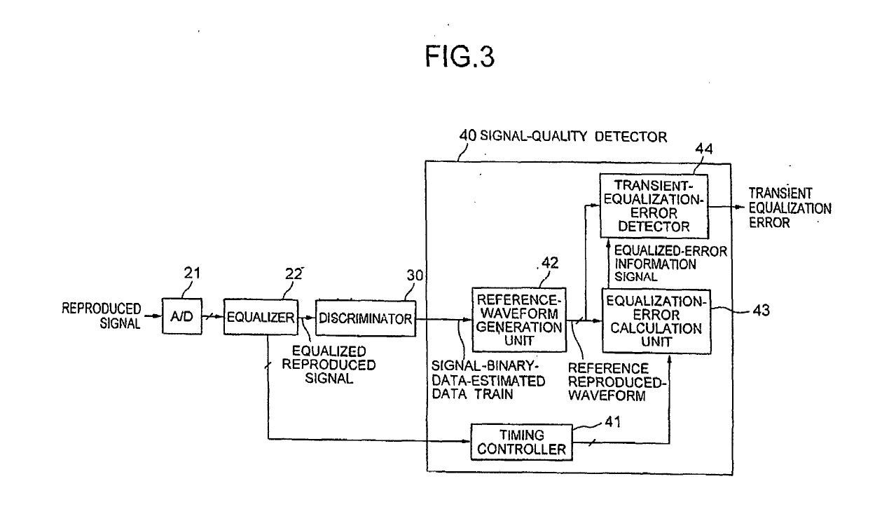

The signal-quality detector 40 calculates a transient equalization error based on the equalized reproduced signal output from the equalizer 22 and the binary data (estimated data train) output from the discriminator 30. FIG. 3 shows the configuration of the signal-quality detector 40. The signal-quality detector 40 includes a timing control circuit 41, a reference-waveform generation unit (reference-waveform generation section) 42, an equalization-error calculation unit 43, a transient-equalization-error detector (transient-equalization-error detection unit) 44. The reference-waveform generation unit 42 generates a reference reproduced-waveform that is obtained by applying a desired PR characteristic (PR(1,2,2,2,1) characteristic) to the decoded binary data output from the discriminator 30. The reference reproduced-waveform can be obtained by calculation of convolution of the binary data train and the PR equalization characteristic, and is an ideal waveform which can be generated independently to some extent. The binary data train to be used for generation of the reference waveform is not limited only to the output form the discriminator 30 and may be a recording data train stored in the storage section. In this case, the binary data train is of an ideal waveform which can be generated completely independently. The generation-timing control circuit 41 controls the output timing of the equalized reproduced-signal waveform so that the equalized reproduced-signal waveform output from the equalizer 22 and the reference reproduced-waveform output from the reference-waveform generation unit 42 are input to the equalization-error calculation unit 43 at a matched timing.

The equalization-error calculation unit 43 calculates equalization error information showing the error between the reference reproduced-waveform and the equalized reproduced-signal waveform. The transient-equalization-error detector 44 extracts the equalization error information as the transient equalization error at a time instant at which the reference reproduced-waveform assumes a specific value, and at which the specific value and the reference reproduced-waveform at another time instant which is m channel clocks (m is an integer not smaller than 1) before or after the time instant satisfy therebetween a specific relative relationship. The transient-equalization-error detector 44 includes an integration circuit that integrates together the transient equalization errors extracted and an average calculation circuit that calculates the average from the integrated value integrated by the integration circuit, although illustration thereof is omitted herein. The integration and calculation of the average by theses circuits are performed in an arbitrary period, for example, by ECC block. In an alternative, the integration and calculation may be performed by a plurality of ECC blocks as a unit, may be performed by a sector or frame, or may be performed by a combination of those periods as a unit.

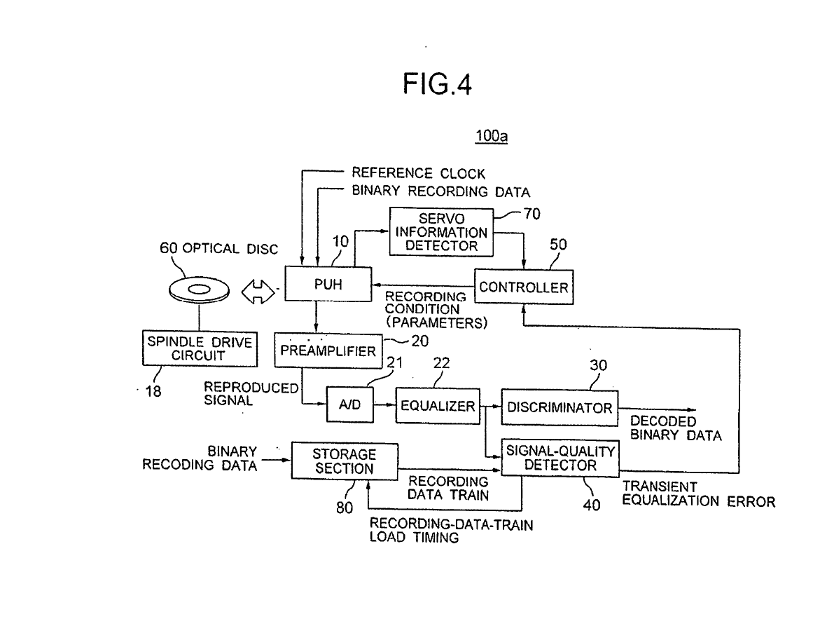

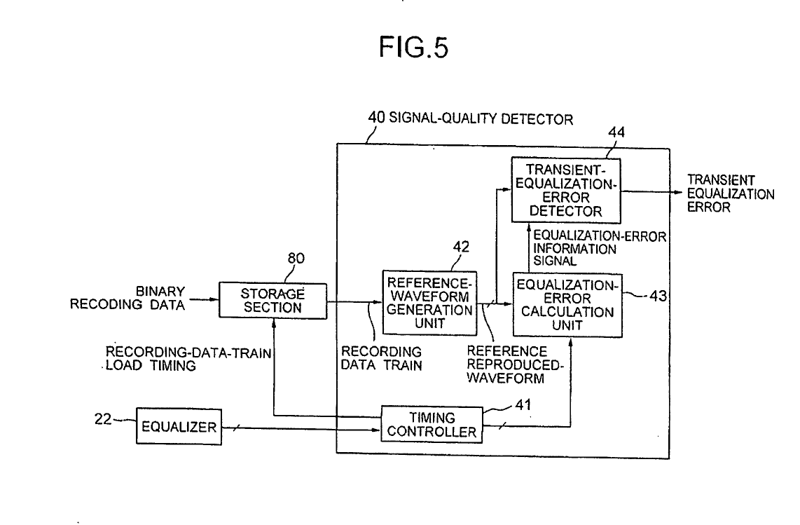

In the above description, calculation of the equalization error used the estimated data train output from the discriminator 30; however, the equalization error information may be calculated using the data train (original data) actually used for the recording instead. FIGS. 4 and 5 show the configuration of the optical information recording/reproducing unit used in this case. The optical information recording/reproducing unit 100a of this modification includes a storage section 80 that stores therein the recording data train (binary recording data) that has been recorded on the optical disc 60. The signal-quality detector 40 reads out the recording data train corresponding to the equalized reproduced-signal waveform from the storage section 80 based on the recording-data-train load timing signal generated by the timing control circuit 41 (FIG. 5), and then calculates the equalization error information.

Hereinafter, description is given to the quality index that is used in the present exemplary embodiment and shows the positional deviation of the recorded mark. The condition assumed here is such that a mark or space recorded in a (1, 7) RLL constraint is to be subjected to a PR(12221)+ML detection, such that the reproduced signal waveform is reproduced from the information including the mark and space recorded on the optical information recording medium and the reference reproduced-waveform is obtained by inputting the reproduced signal waveform to the discriminator, which provides an estimated data train therefrom, and by applying the PR12221 thereto, as the specific response characteristic, and such that the equalized error waveform that is calculated as the difference between these waveforms is obtained as a continuous train of level-values corresponding to the channel clock.

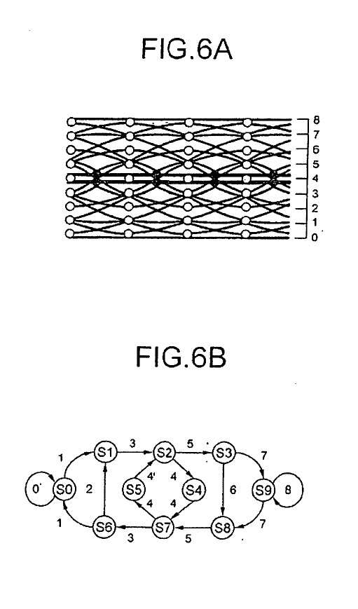

FIG. 6A shows the reproduced eye-pattern waveform obtained by reproduction of a recorded mark train, which is recorded in the (1, 7) RLL, by using the PR(1,2,2,2,1) equalization. FIG. 6B is a state transition diagram showing the way of signal transition. A blank circle in the eye-pattern waveform of FIG. 6A represents a discrimination point. The reproduced signal assumes nine levels in the case of the PR(1,2,2,2,1) characteristic. The signal having a constraint in the run length thereof behaves to follow the rule that the signal assumes nine levels shown in FIG. 6A and changes the state thereof at any channel clock.

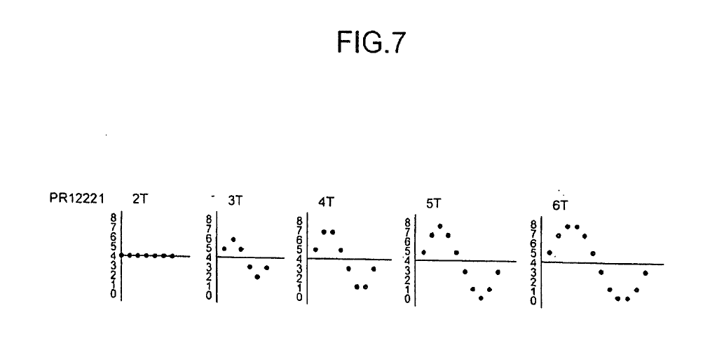

FIG. 7 shows the reference reproduced-waveform of 2T-6T obtained by applying the PR12221 equalization onto patterns 2T-8T of (1, 7)RLL. Since the level of 0 and 8 assumes the same value per clock, illustration for 7T and 8T is omitted herein. It is assumed here that the specific value is the central level “4”, for example. The level “4” is a level that appears only in the 2T pattern in the case of PR(1,2,2,2,1) equalization. It is defined here that the value that the equalization error waveform, which is obtained as the difference between the reproduced signal waveform and the reference reproduced-waveform, assumes at the time instant at which the reference reproduced signal assumes level “4”, especially after changing from another value at one channel clock before or after the time instant is the transient equalization error, among other values that the equalization error assumes at the time instant at which the reference reproduced-waveform assumes level “4”. In this case, the controller 50 (FIG. 1) can estimate the recorded quality of a 2T mark or space by using the transient equalization error corresponding to a change to the level “4” or a change from the level “4” as the quality index showing the positional deviation of the recorded mark.

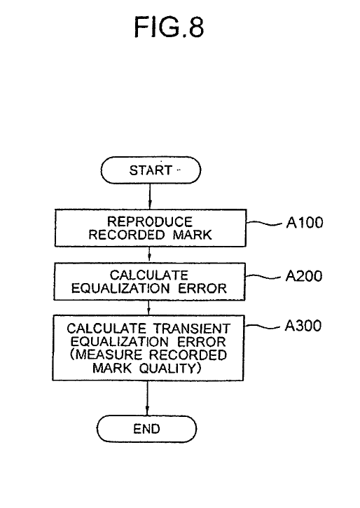

FIG. 8 shows the processing flow of quality measurement of the recorded mark in the optical information recording/reproducing unit 100. It is assumed here that recording was performed beforehand on the optical disc 60 under a specific recording condition. The PUH 10 (FIG. 1) reads out the marks and spaces recorded on the optical disc 60, to obtain a reproduced signal waveform (step A100). The equalization-error calculation unit 43 calculates the equalization error that is an error between the reproduced signal waveform and the reference reproduced-waveform obtained by applying the specific response characteristic (step A200). Thereafter, the transient-equalization-error detector 44 extracts, as an transient equalization error, the equalization error at the time instant at which the reference reproduced-waveform assumes a specific value, and at which the specific value and a value of the reference reproduced-waveform m channel clocks (m is an integer not smaller than one) before or after the time instant satisfy therebetween a specific relative relationship, and deems the extracted transient equalization error as the quality index that represents the positional deviation of the recorded mark (step A300).

The controller 50 (FIG. 1) controls the LD drive circuit 13 (FIG. 2) of the PUH based on the results of detection of the signal quality index in the signal-quality detector 40, and controls the shape of the recording laser pulse. The controller 50 performs recording while changing parameters of the recording laser pulse shape, such as the position of the front edge, rear edge and the power, reproduces the recorded data, and selects the parameters of the recording laser pulse shape that allow suitable recording based on the results of detection by the signal-quality detector 40 during the reproduction. In an alternative, the correlation between the result of detection in the signal-quality detector 40 and the parameters of the recording laser pulse shape may be studied and stored beforehand, and the parameters of the recording laser pulse shape may be determined using the correlation from the result of detection (amount of error) by the signal-quality detector 40. In a further alternative, a configuration may be employed wherein a series of processings including calculation of transient equalization error during the recording and reproduction, evaluation thereof, and change of parameters of the recording condition is iterated, and the recording laser pulse shape is adaptively controlled.

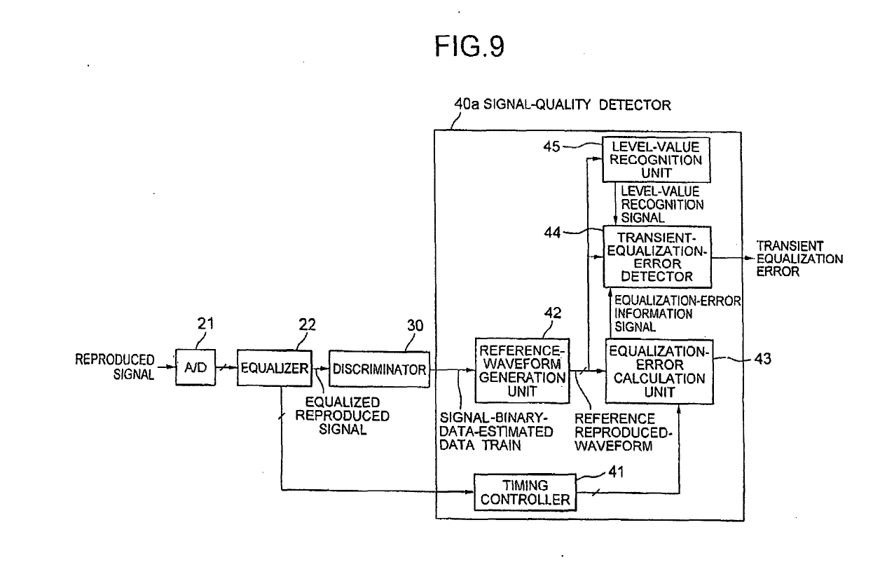

FIG. 9 shows the configuration of the signal-quality detector provided in an optical information recording/reproducing unit according to a second exemplary embodiment of the present invention. In addition to the configuration of the signal-quality detector 40 in the first exemplary embodiment shown in FIG. 3, the signal-quality detector 40a used in the present exemplary embodiment includes a level-value recognition unit 45. In the first exemplary embodiment, the equalization error upon transition of the reference reproduced-waveform to the specific level and transition thereof from the specific level is defined as the transient equalization error, and used as the index based on which the signal quality is judged. On the other hand, the level-value recognition unit 45 is used in the present exemplary embodiment to recognize the level-value before and after the transition, to classify the case based on the same.

Hereinafter, the level-value recognition will be described. Considering that the level changes to level “4” from a time instant one channel clock before, for example, the state transition diagram shown in FIG. 6B has two paths: a path (path-1) of S 8→S7→S5 (5→4 in terms of amplitude level-value); and a path (path-2) of S 1 →S 2→S4 (3→4 in terms of amplitude level-value). This corresponds to the fact that the state is recorded by a mark or space, and it is determined here that the path-1 corresponds to the mark and the path-2 corresponds to the space, in the case of a recording medium on which the mark is brighter than the space, for example.

As to the above path-1, the specific value (level-value “4”) corresponds to the mark, and the level-value at one channel clock before corresponds to the space because the level is different from the specific value, whereby it is defined that the level “4” in the path-1 corresponds to the front edge of a 2T mark. Similarly, the specific value in the path-2 corresponds to the space, the level at one channel clock before corresponds to the mark because the level is different from the specific value, whereby it is determined that the level “4” in the path-2 corresponds to the front edge of a 2T space. In other word, for the case where the level-value “4” is the specific value, the transition of level-value is such that the path-1 corresponds to 5(space)→4 (mark) and the path-2 corresponds to 3(mark)→4(space). The transient equalization error corresponding to the path-1 is denoted by a transient equalization error (LH 2TF) that corresponds to the front edge of the 2T mark, whereas the transient equalization error corresponding to the path-2 is denoted by a transient equalization error (HL 2TF) that corresponds to the front edge of the 2T space.

Considering the case, where the level changes from the level-value “4” at one channel clock after, in the state transition diagram showing in FIG. 6B, there are a path of S5→S2→S3 (4→5 in terms of the amplitude level) and a path of S4→S7→S6 (4→3 in terms of the amplitude level). The level “4” in these paths are defined as the rear edge of the 2T mark and 2T space, and the equalization error information for the level “4” in these paths is defined as a transient equalization error (LH 2TR) corresponding to the rear edge of the 2T mark, and as a transient equalization error (HL 2TR) corresponding to the rear edge of the 2T space.

As to the front edge and rear edge of a 3T mark or 3T space, since the level-values “2” and “6” are the values that only the 3T pattern assumes after the PR(1,2,2,2,1) equalization, these level-values can be defined by the level-values “5” and “3” in a transition from the level-value “5” to the level-value “6” or in the opposite direction thereof, and a transition from the level-value “3” to the level-value “2” or in the opposite direction thereof. As to the front edge and rear edge of a 4T or longer mark or a 4T or longer space, these level-values can be defined by the level-values “5” and “3” in a transition from the level-value “5” to the level-value “7” or in the opposite direction thereof, and a transition from the level-value “1” to the level-value “3” or in the opposite direction thereof. The equalization error for the front edge and rear edge of these marks or space are defined as a transient equalization error corresponding to the respective mark lengths or respective space lengths.

The following Table 1 shows the transient equalization errors for the front edge and rear edge of those mark lengths and space lengths.

TABLE 1

| | Specific | Transition of | Transition |
|---|---|---|---|
| | Value | Level | Equalization Error |
| Front Edge of 2T | 4 | 5→4 | Front Edge of 2T Mark (LH |
| | | | 2TF) |
| | 4 | 3→4 | Front Edge of 2T Space (HL |
| | | | 2TF) |
| Rear Edge of 2T | 4 | 4→5 | Rear Edge of 2T Mark (LH |
| | | | 2TR) |
| | 4 | 4→3 | Rear Edge of 2T Space (HL |
| | | | 2TR) |
| Front Edge of 3T | 3 | 3→2 | Front Edge of 3T Mark (LH |
| | | | 3TF) |
| | 5 | 5→6 | Front Edge of 3T Space (HL |
| | | | 3TF) |
| Rear Edge of 3T | 3 | 2→3 | Rear Edge of 3T Mark (LH |
| | | | 3TR) |
| | 5 | 6→5 | Rear Edge of 3T Space (HL |
| | | | 3TR) |
| Front Edge of 4T | 3 | 3→1 | Front Edge of 4T or Longer |
| or Longer | | | Mark (LH 4TF) |
| | 5 | 5→7 | Front Edge of 4T or Longer |
| | | | Space (HL 4TF) |
| Rear Edge of 4T | 3 | 1→3 | Rear Edge of 4T or Longer |
| or Longer | | | Mark (LH 4TR) |
| | 5 | 7→5 | Rear Edge of 4T or Longer |
| | | | Space (HL 4TR) |

Table 1 shows that the specific value is determined at, for example, “4” and that the transient equalization error (LH 2TF) corresponding to the front edge of the 2T mark, for example, is defined by the equalization error at the level-value “4” during the transition from “5” to “4” in the level-value.

It is to be noted that the optical disc media include ones wherein the reflectance thereof changes from “low” to “high” along with a change from the non-recorded state to the recorded state. i.e., the mark is recorded to be brighter than the space, and others wherein the reflectance thereof changes from “high” to “low” along with the same state change, i.e., the mark is recorded to be darker than the space. With respect to the mark or space in those media, the correspondence (polarity) of the reproduced (input) signal is arbitrarily changed by the signal processing performed later, and handled in the specific definition of the device, controller measurement unit and human operation, whereby the correspondence of the mark or space is arbitrarily changed for the use thereof.

All the marks or spaces that range 2T to 4T or longer as well as the front edge and rear edge thereof are not necessarily needed for the processing, and specific values may be suitably used. These transient equalization errors may be used in a form that is easy to handle after the arithmetic processing thereof to obtain an average or variance thereof. In consideration of the circuit operation in an actual processing, those values may be used in a chronological order; however, use of the integral or average of those values over a fixed period allows the tendency of the recorded state to be judged with ease, thereby facilitating the recognition processing, correspondence processing, etc.

The level-value recognition unit (FIG. 9) performs judgment processing on whether the equalized reproduced-signal waveform corresponds to the mark or space on the optical information recording medium based on the level-value or transition of the level-value of the reference reproduced-waveform. In an alternative, level-value recognition unit 45 performs judgment processing on whether the equalized reproduced-signal waveform corresponds to the front edge or rear edge of the mark or space on the optical information recording medium based on transition of the level-value of the reference reproduced-waveform. The level-value recognition unit 45 outputs a level-value recognition signal, to notify the transient-equalization-error detector 44 of the classification between the mark and the space as well as the front edge and the rear edge. The transient-equalization-error detector 44 extracts the transient equalization error that is classified between the front edge and the rear edge corresponding to the mark state and space state, transition from the space to the mark, or transition from the mark to space.

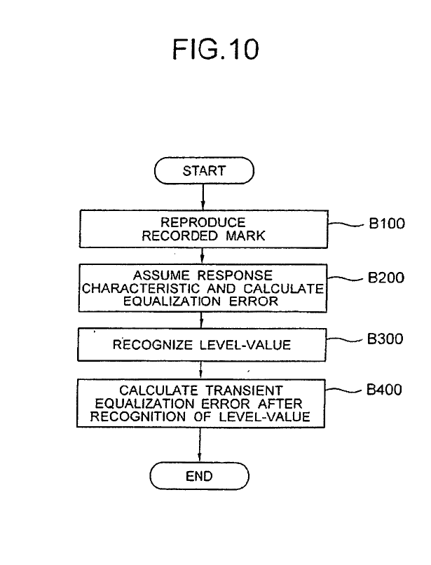

FIG. 10 shows the processing flow of quality measurement of the recorded mark in the optical information recording/reproducing unit of the present exemplary embodiment. It is assumed that recording is performed on the optical disc 60 beforehand under a specific recording condition. The PUH 10 (FIG. 1) reads out the marks and spaces recorded on the optical disc 60, to obtain the reproduced signal waveform (step B100). The equalization-error calculation unit 43 calculates the equalization error that is an error between the reproduced signal waveform and the reference reproduced-waveform obtained by applying the specific response characteristic (step B200). The operation up to this step is similar to that of the first exemplary embodiment.

The level-value recognition unit 45 recognizes whether the reproduced signal waveform corresponds to the mark or space on the optical information recording medium based on the level-value or transition of the level-value of the reference reproduced-waveform. In an alternative, the level-value recognition unit 45 recognizes whether the reproduced waveform corresponds to the front edge or rear edge of the mark or space on the optical information recording medium for the transition of the level-value of the reference reproduced-waveform (step B300). The transient-equalization-error detector 44 extracts the transient equalization error that is classified as the front edge or rear edge in accordance with the state as to whether the reproduced waveform is the mark or space, or the transition state as to whether it is a transition from the space to the mark or a transition from the mark to the space, that is recognized by the level-value recognition unit 45 from the equalization error information calculated by the equalization-error calculation unit 43 (step B400). The transient equalization error extracted is used as the quality index showing the positional deviation of the recorded mark.

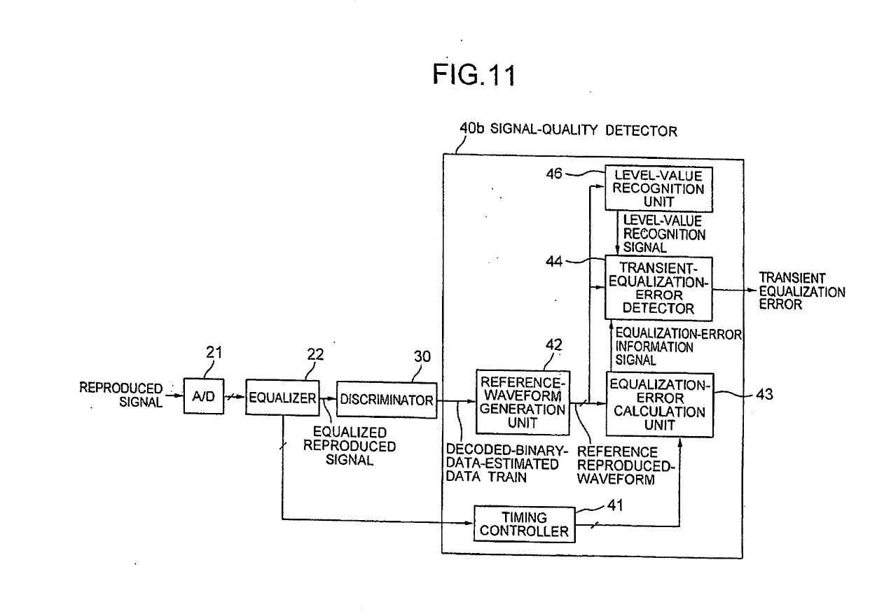

FIG. 11 shows the configuration of the signal-quality detector provided in an optical information recording/reproducing unit according to a third exemplary embodiment of the present invention. In addition to the configuration of signal-quality detector 40 in the first exemplary embodiment shown in FIG. 3, the signal-quality detector 40b used in the present exemplary embodiment includes a level-group recognition unit 46. In the second exemplary embodiment, using the level-value recognition unit 45, the level-value at one channel clock ahead or behind the specific level-value is recognized to discriminate the front edge or rear edge of the mark or the space. On the other hand, in the present exemplary embodiment, the level-value transition within a plurality of channel clocks before and after the specific level-value is recognized, to classify the case in more detail as to the front edge and rear edge of the mark or the space.

The level-group recognition unit 46 stores therein, as the level group, the transition pattern of the level-value within a plurality of channel clocks until the reproduced signal waveform assumes the specific level-value, and the transition pattern of the level-value within a plurality of channel clocks after the reproduced signal reaches the specific level-value. The level-group recognition unit 46 stores, as the level group, transition of the level-value within (n−1)T clocks, for example, with respect to a record length of nT (n is a natural number) for the recorded mark or the recorded space to be detected. The level-group recognition unit 46 monitors transition of the level-value of the reproduced signal waveform, to detect a transition pattern that matches one stored in the level group.

The level-values obtained by performing the PR12221 equalization onto patterns 2T-8T of (1,7) RLL include nine values having nine levels, and the reproduced signal waveform (reference reproduced-waveform) assumes level-values of 0-8, as shown in FIG. 7. It is assumed that the level-value larger than 4 corresponds to the recorded mark recorded on the medium, whereas the level-value smaller than 4 corresponds to the recorded space. The transition of level-value of 7T pattern and 8T pattern are similar to that of the 6T pattern except that the number of continued level-values “0” and “8” is different from that of the 6T pattern.

In the case of PR12221, the correspondence of the recorded mark or space at the level-value “4” is determined by the relationship with respect to the value ahead or behind the-level value “4”. The level-group recognition unit 46 classifies the level-value “4”, for example, by using the level group wherein the level-value assumes 2→3→4 (path of S6 →S1→S2→S4 in the state transition diagram of FIG. 6B), and the level group wherein the level-value assumes 1→3→4 (path of S0→S1→S2→S4 in the state transition). This allows classification between the transient equalization error corresponding to 2T upon a transition from 3T to 2T and the transient equalization error corresponding 2T upon a transition from 4T (or longer) to 2T. In addition, the span of transition through a plurality of level-values may be extended, wherein the transition of 1→3→4 may be classified between the level group of 1→1→3→4 and the level group of 0→1→3→4.

Next, a case is considered where the level-value “3” in the 4T pattern, i.e., n is equal to 4 in the nT pattern, is to be judged. With reference to FIG. 7, this level-value “3” exists in the 5T, 6T, 7T, and 8T other than the 3T. Comparing these patterns in the transition of level-value after the time instant of level-value “3” including the same time instant, the transition advances along “3”, “1”, and “1” in the 4T pattern, whereas the transition advances along “3”, “1”, “0”, and “1” in the 5T pattern, and along “3”, “1”, “0”, “0”, and “1” in the 6T pattern, whereby the way of transition is different between the patterns. In addition, since the level-value lower than “4” corresponds to the recorded space, this 4T pattern corresponds to the 4T space. Thus, use of the level group of “3”, “1”, and “1” allows recognition of the level-value “3” corresponding to the 4T mark.

Similarly, a case is considered where the level-value “5” in the 4T pattern is to be judged. This level-value “4” exists in the 5T, 6T, 7T, and 8T other than the 3T. Comparing these patterns in the transition of level-value before the time instant of level-value “5” including the same time instant, the transition advances along “7”, “7”, and “5” in the 4T pattern, whereas the transition advances along “7”, “8”, “7”, and “5” in the 5T pattern, and along “7”, “8”, “8”, “7”, and “5” in the 6T pattern, whereby the way of transition is different between the patterns. Since the level-value higher than “4” corresponds to the recorded mark, use of the level group of “7”, “7”, and “5” allows recognition of the level-value “5” corresponding to the 4T mark.

In the above description, the nT mark or space is recognized using the level group including transition of level-value within (n−1)T clocks. However, a variety of cases may be classified corresponding to the recorded marks or recorded spaces, so long as the transition of level-value in the level group is not limited to that within the (n−1)T clocks. Preparation of level groups corresponding to other level-values ahead or behind the specific level-value, if any, allows classification of the marks or spaces ahead or behind the specific level-value, whereby a detailed classification such as the nT mark or space succeeding to a mT mark or space, or a mT mark or space succeeding to an nT mark or space (m is an integer) may be possible. It is to be noted that m and n satisfy m>1 and n>1 in the (1,7) RLL.

For example, a case is considered wherein a 3T mark and a 4T or longer mark are classified therebetween, when provided ahead or behind a 2T space (level-value “4”). The following four level groups are prepared:

2,3,4,4,3,2;
2,3,4,4,3,1;
1,3,4,4,3,2; and
1,3,4,4,3,1.

In this case, use of the level group “2,3,4,4,3,2” provides recognition of the level-value “4” in the case of sequential arrangement of a 3T mark, a 2T space and a 4T or longer mark. Use of the level group “2,3,4,4,3,1” provides recognition of the level-value “4” in the case of sequential arrangement of a 3T mark, a 2T space and a 4T or longer mark. Use of the level group “1,3,4,4,3,2” provides recognition of the level value “4” in the case of sequential arrangement of a 4T or longer mark, a 2T space and a 3T mark, and use of the level group “1,3,4,4,3,1” provides recognition of the level-value “4” in the case of sequential arrangement of a 4T or longer mark, a 2T space and a 4T or longer mark.

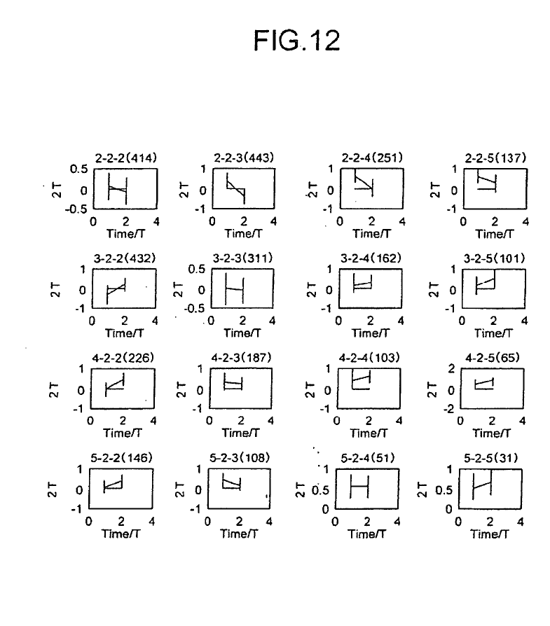

The result of recognition by the level-group recognition unit 46 shows which combination of the marks and spaces the level-value of the reproduced signal waveform at the time instant of obtaining the transient equalization error corresponds. The transient-equalization-error detector 44 classifies the transient equalization error for each recognized combination based on the result of recognition by the level-group recognition unit 46. FIG. 12 exemplifies that the transient equalization error corresponding to a 2T mark is classified depending on the space length ahead and behind the 2T mark. FIG. 12 shows the average value and dispersed state (width of the variance) of the transient equalization error of the front edge and rear edge of the 2T mark in the combination of the space length (2T, 3T, 4T, 5T) of the space preceding the 2T mark and the space length ( 2T, 3T, 4T, 5T) of the space succeeding the 2T mark. The “2-2-3” in the figure denotes the combination of a 2T space, a 2T mark, and a 3T space, and the number in the parenthesis denotes the number of appearances of this combination (sample number) included in the random pattern. In each graph, the position where the transient equalization error (ordinate) assumes zero is the reference position (target position).

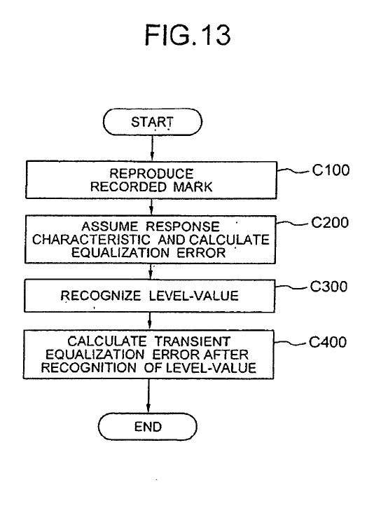

FIG. 13 shows the processing flow of quality measurement of the recorded mark in the optical information recording/reproducing unit of the present exemplary embodiment. It is assumed that recording is performed beforehand on the optical disc 60 under a specific recording condition. The PUH 10 (FIG. 1) reads out the marks and spaces recorded on the optical disc 60, to obtain the reproduced signal waveform (step C100). The equalization-error calculation unit 43 calculates the equalization error that is an error between the reference reproduced-waveform obtained by applying the specific response characteristic and the reproduced signal waveform (step C200). The operation up to this step is similar to that of the first exemplary embodiment.

The level-group recognition unit 46 judges using the level group which combination of the marks and spaces the level-value of the reference reproduced-waveform at the time instant of obtaining the transient equalization error corresponds (step C300). The transient-equalization-error detector 44 classifies the combination of the marks and spaces based on the result of recognition by the level-group recognition unit 46, to extract the transient equalization error (step C400). The transient equalization error thus extracted is used as the quality index showing the positional deviation of the recorded mark.

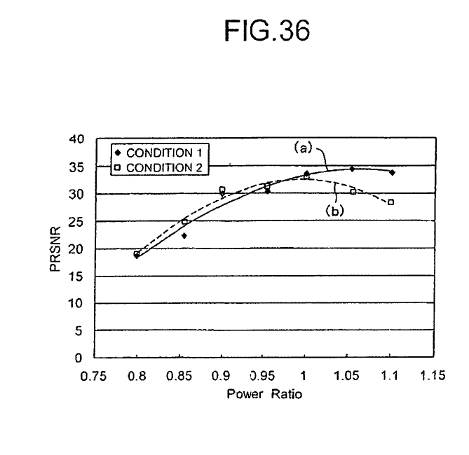

Hereinafter, the advantages will be described using the results of investigation performed until the present invention could be accomplished. Two conditions (condition-1 ( [symbol] ) and condition-2( [symbol] )) are considered that provide different recording positions to the 2T mark shown in FIG. 36 and are described in the part of problem to be solved. The optical information recording/reproducing unit used herein is an optical information recording/reproducing unit having a NA (numerical aperture) of 0.65 for the objective lens provided in the optical head, and a LD wavelength, λ, of 405 nm, and is used for recording on a write-once optical disc having a diameter of 120 mm, a substrate thickness of 0.6 mm, a track pitch of 0.4 μm, under a minimum bit length of 0.153 μm/bit in the (1,7) RLL by using the condition- 1 ( [symbol] ) and condition- 2 ( [symbol] ), under which the 2T mark, i.e., the shortest mark, is formed at different positions while using a power ratio of 1.

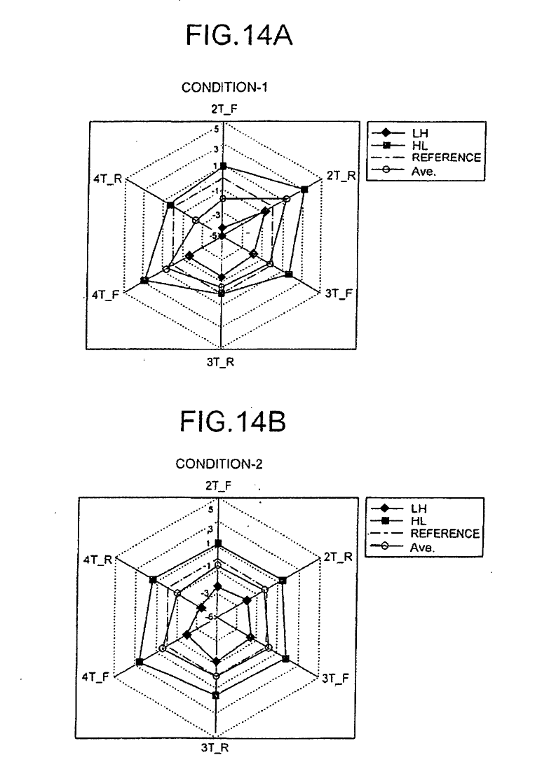

FIGS. 14A and 14B show the results of plotting the transient equalization errors of the mark or space obtained under the condition-1 and condition-2, respectively. In these figures, LH denotes the recorded mark, HL denotes the recorded space, and the reference denotes the target value (transient equalization error=0) obtained in the assumed ideal system. The 2T_F and 2T_R denote the front edge and rear edge, respectively, of the 2T pattern, and the 3T_F and 3T_R denote the front edge and rear edge, respectively, of the 3T pattern. The 4T_F and 4T_R denote the front edge and rear edge, respectively, of the 4T or longer pattern.

The average (Ave) means the average of the value of the front edge and rear edge of each pattern. In FIGS. 14A and 14B, the fact that the error of each mark or space is comparable to the reference (target) without a deviation therefrom, and that the average of each mark or space is closer to the reference means a smaller error after all.

Comparing the condition-1 (FIG. 14A) and the condition-2 (FIG. 14B) against each other, the condition-2 has a smaller deviation with respect to the reference as compared to the condition-1 in the error of each mark or space, and also the average for the mark or space is closer to the reference. This means that these conditions have therebetween a difference in the margin for the power with respect to the range (margin) that can be detected by the PRML depending on the position at which the mark or space is located, as shown in FIG. 36. In this example, it is shown that the condition-1 under which the mark or space is formed nearer to the detection limit (limit of the margin) has a narrower power margin compared to the condition-2. From the reason as described heretofore, the validity of the technique for measuring the recorded-mark quality and the capability of selecting the condition having a larger margin is confirmed in each above exemplary embodiment.

Verification was performed as to whether the quality of the recorded mark can be improved by the recording control so as to reduce the transient equalization error a whether or not the recording control is applicable in the case of raising the recording density by using another type of disc medium for which a different process is used for forming the recorded mark (rewritable-type phase change medium). The optical head used herein was one that had a numerical aperture, NA, of 0.65 for the objective lens, and a LD wavelength, λ, of 405 nm, similarly to that described above, and the optical disc used was one that had a diameter of 120 mm, a polycarbonate substrate which had a substrate thickness of 0.6 mm, and on which a guide groove for a land/groove format was formed. The density of recorded data was such that the bit pitch was 0.13 μm, and the track pitch was 0.34 μm, and the recording film used was a phase-change recording film (rewritable type) for which recording is performed by phase change.

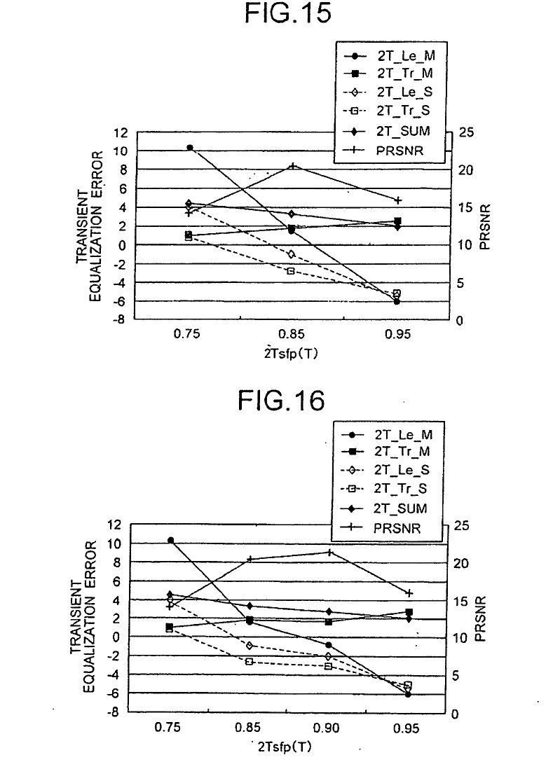

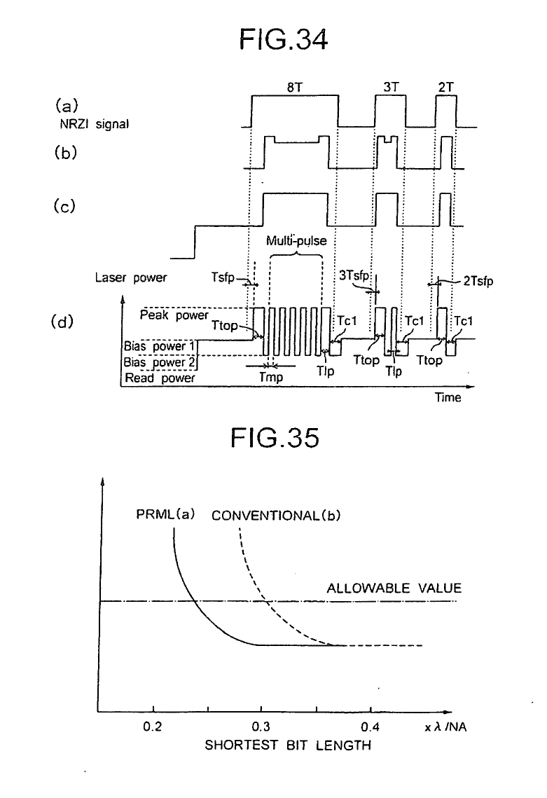

FIG. 15 shows the relationship between the 2Tsfp and the transient equalization error for the case where the time width of the recording pulse waveform shape is constant upon forming a 2T pattern and where the recording start timing 2Tsfp (FIG. 34) for the 2T mark is changed. The same figure also shows additionally the relationship between the 2Tfsp and the PRSNR that is the quality evaluation index. The transient equalization error was obtained by classifying the front edge and the rear edge of the mark or space, i.e., by classifying the transient equalization error at the front edge of the 2T mark (□: 2T_Le_M), transient equalization error at the rear edge of the 2T mark (▪:2T_Tr_M), transient equalization error at the front edge of the 2T space (□: 2T_Le_S) and the equalization error at the rear edge of the 2T space (□:2T_Tr_S). In addition, calculation of integration was also performed without classifying the transient equalization error for the front edge and the rear edge of the mark or space to thereby obtain the integrated value (: 2T_SUM). Use of the transient equalization error classified between the front edge and the rear edge of the mark or space, in addition to the integrated value, allows the balance and constituent ratio of the constituent elements to be judged with ease.

A smaller value of the transient equalization error corresponds to a smaller deviation, whereby the condition that provides a uniform transient equalization error and a transient equalization close to the reference (target) transient equalization error for the mark or space is equivalent to the condition that allows an excellent recording. This condition corresponds to the integrated value 2T_SUM () being close to zero. FIG. 15 shows that the 2T_SUM is close to zero when 2Tsfp=0.85. Measurement of PRSNR, if performed, reveals that a highest PRSNR is obtained when 2Tsfp=0.85, whereby this condition may be considered as a suitable recording condition. However, the transient equalization error with respect to the reference is different between the front edge (□) of the 2T mark and the rear edge (□) of the 2T mark, which means a poor balance, for the case of 2Tsfp=0.85. Thus, the calibration is deemed insufficient, and a balancing calibration is tried by enlarging the 2Tsfp, related to the front edge, as the parameter equivalent to the front edge of 2T.

The trial of the balancing calibration is performed by recording/reproducing under the condition of 2Tsfp=0.90 due to the constraint of the setting accuracy of Tsfp, to calculate the transient equalization error and measure the PRSNR at the same time. FIG. 16 shows the results of trial balancing calibration, added to the graph shown in FIG. 15. In the results, the 2T_SUM approached nearer to zero for the case of 2Tsfp=0.90 as compared to the case of 2Tsfp=0.85, and the error with respect to the reference became uniform between the front edge of the 2T mark (□) and the front edge of the 2T space (□). It was also confirmed that the PRSNR was improved for the case of 2Tsfp=0.90.

As described heretofore, it was confirmed that the positional deviation of the recorded mark can be detected with a higher degree of accuracy by using the transient equalization error as a performance index of the signal quality, and that a high-quality recorded mark can be obtained comprehensively by controlling the recording while calibrating the waveform so as to reduce the transient equalization error. It was also confirmed that this technique can be used to other types of the disc medium for which the recorded mark is formed by different processes, and can be applied in the case of further raising the recording density, to thereby show the validity of this technique.

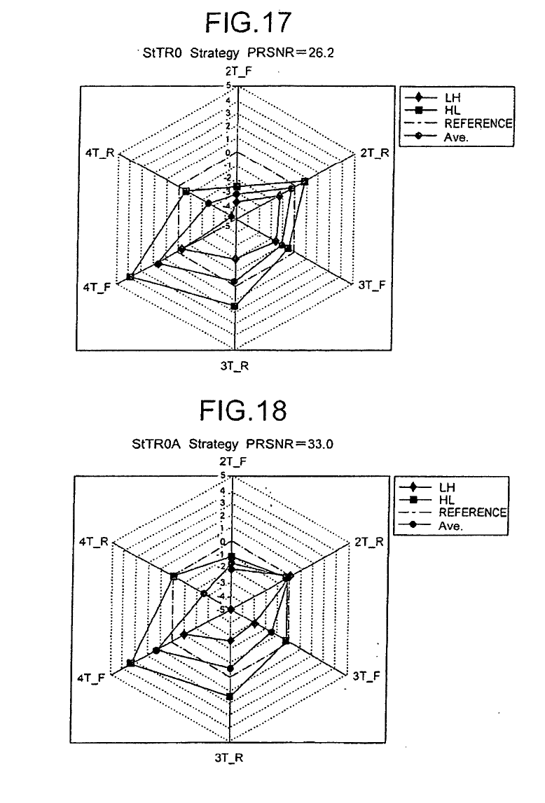

The present inventors also found that the shortest mark or shortest space or the mark or space having one recording length (one channel clock) longer than the shortest mark or shortest space incurs a significant influence on the recording/reproducing performance, in the case of such a higher recording density that the performance cannot be assured without using the PRML detection. FIGS. 17 and 18 show the transient equalization error corresponding to the front edge and rear edge of the 2T pattern, 3T pattern and 4T or longer pattern that are recorded under different recording conditions for forming the 2T and 3T.

In FIGS. 17 and 18, LH denotes the recorded mark and HL denotes the recorded space. 2T_F and 2T_R denote the front edge and rear edge, respectively, of the 2T pattern, and 3T_F and 3T_R denote the front edge and rear edge, respectively, of the 3T pattern. 4T_F and 4T_R denote the front edge and rear edge, respectively, of the 4T or longer pattern. The average (Ave.) means the average of the front edge and rear edge of each pattern. Comparing FIG. 17 and FIG. 18 against each other, the transient equalization error is of a similar degree between the front edge and the rear edge of the 4T or longer pattern; however, the transient equalization error of the shortest pattern 2T, and the 3T pattern that is next to the shortest pattern is different from that of the 4T or longer pattern, whereby there arises a performance difference in the PRSNR, as shown between 26.2 (FIG. 17) and 33.0 (FIG. 18). This is because the ratio of number of the shortest patterns and the patterns next to the shortest pattern to the total number of marks is higher than that of the other patterns, and because the SN ratio of the shortest pattern has a higher influence on the state of formation thereof as compared to the longer patterns which are relatively easy to assure the performance of the SN ratio.

As described above, the present invention allows detection of the positional deviation of the recorded mark with a higher degree of accuracy, which is recorded at a higher recording density on an optical information recording medium. This is because the detection of positional deviation of the recorded mark is suited to the higher-density recording/reproducing/detecting technique The present invention achieves also the advantage that a high-quality mark can be formed in a high density recording due to employing a suitable recording condition that can increase the margin. This is because the positional deviation (error) of the recorded mark recorded in a high density recording is detected with a higher degree of accuracy, which allows control of the recording condition to reduce the positional deviation of the recorded data.

The present invention provides a higher-speed calibration of the recording condition prior to actual recording of information. This is because all the parameters need not be necessarily optimized by measuring the margin for respective parameters, and because correction of the positional deviation of the recorded mark recorded at a higher density can be performed efficiently without waste of time and thus calibration of the recording condition can be performed at a higher speed, by detecting the positional deviation of the recorded mark with a higher degree of accuracy for quantization thereof. In the present invention, a large area is not needed for optimization of the parameters because all the parameters need not be optimized by measuring the margins for the respective parameters, and the positional deviation of the recorded mark can be accurately corrected by accurately detecting the positional deviation of the recorded mark recorded by a higher density recording. This suppresses use of a wasted area and reduces the waste of the calibration area upon calibration of the recoding condition.

The present invention allows formation of the recorded mark more adapted to a higher-density recording/reproducing/detecting technique that is used to reproduce a mark recorded by a higher density recording. This is because the positional deviation of the recorded mark adapted to the higher-density recording/reproducing/detecting technique is detected and used for control of the recording condition under which the mark is to be formed. The configurations of the signal-quality detector shown in FIG. 3, FIG. 9, and FIG. 11 may be suitably selected for use in consideration of the object and degree of the adjustment for educing the disc performance. More specifically, if it is not needed to classify the mark or space and the front edge or rear edge thereof, the signal-quality detector 40a having the configuration shown in FIG. 9 may be used, and if such a classification is needed, the signal-quality detector 40 having the configuration shown in FIG. 3 may be used. If a specific combination of the mark and space is needed in addition to classification of the mark or space and front edge or rear edge thereof, the signal-quality detector 40b having the configuration shown in FIG. 11 may be used.

Hereinafter, the description will be given by using examples.

### EXAMPLE 1

The optical information recording/reproducing unit used in this example was one having a NA of 0.65 for the objective lens in the optical head and a LD wavelength, λ, of 405 nm. The signal-quality detector used therein was the signal-quality detector 40a of the second exemplary embodiment shown in FIG. 9.

The signal-quality detector 40a classified the front edge and rear edge of each of the 2T, 3T, and 4T or longer marks or spaces, and the transient-equalization-error detector 44 extracted (calculated) the transient equalization errors that are classified into these items. The optical information recording medium used herein was an optical information recording medium having a substrate thickness of 0.6 mm, and a bit pitch of 0.153 μm and a track pitch of 0.4 μm as the data density for recording. A write-once optical information recording medium was used herein having a recording film including organic dye and no identification code showing the disc manufacturer.

Generally, upon loading a typical optical disc onto an optical information recording/reproducing unit, the optical information recording/reproducing unit judges the type of the optical disc, and distinguishes the manufacturer thereof. Since the optical disc used in the example-1 has no record of the identification code information of the manufacturer, the disc was handled as an unknown disc. The optical information recording/reproducing unit, after calibrating the servo parameters, read the fundamental strategy that determines the recording laser pulse shape as one of the recording condition parameters, set the same on the LD drive circuit 13 (FIG. 2), and performed recording under four recording conditions (CT1 to CT4) while changing the laser pulse shape. Thereafter, the optical information recording/reproducing unit reproduced the recorded area, classified the front edge and rear edge of the mark or space of the 2T pattern, 3T pattern, and 4T or longer pattern, and calculated in the level-value recognition unit 45 the transient equalization error, average value Ave, and integrated value SUM corresponding to the respective items.

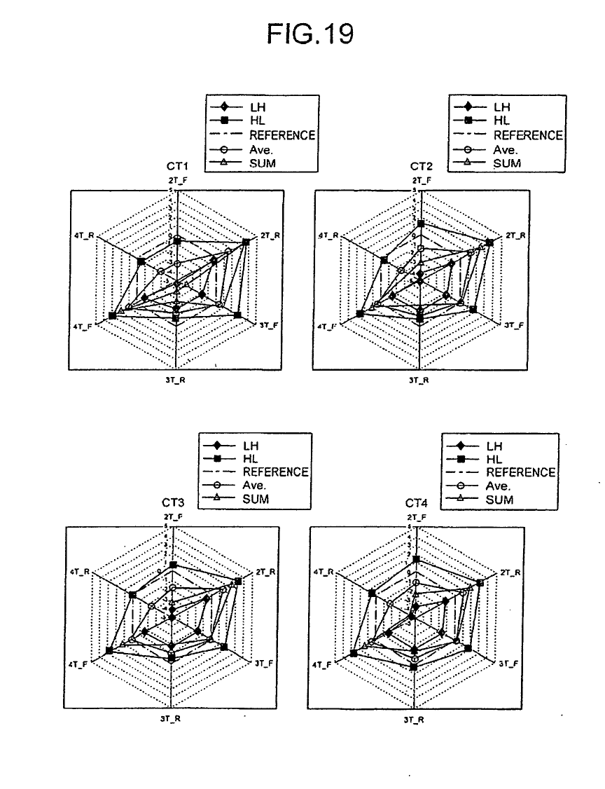

FIG. 19 shows the results of measuring the transient equalization error, average value Ave, and integrated value SUM corresponding to the front edge and rear edge of the mark or space of each pattern under each of the recording conditions CT1 to CT4. In each of the conditions, as to the front edge (_F) and rear edge (_R) of the 2T pattern, 3T pattern, and 4T or longer pattern, the transient equalization error, average value Ave (O) and integrated value SUM (□) corresponding to the mark (LH) or the space (HL) were measured to reveal the results shown in FIG. 19.

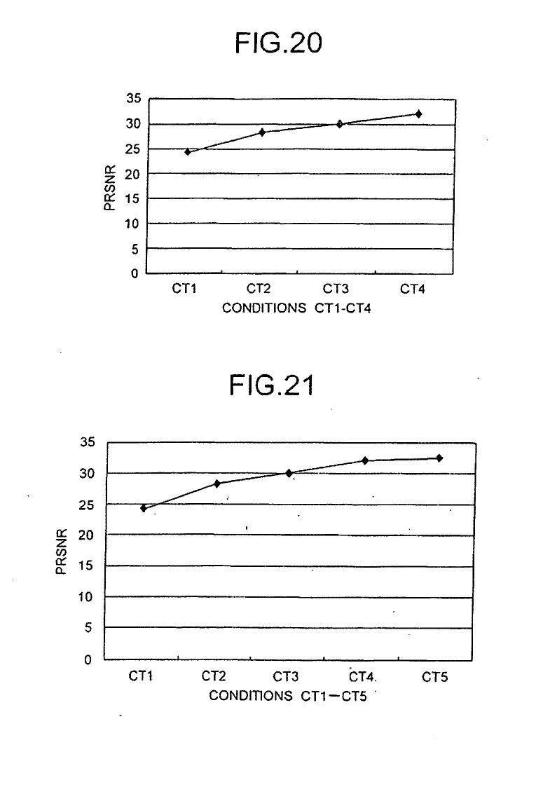

FIG. 20 shows the results of measuring the PRSNR under each recording condition. Observing the results of measuring the PRSNR in each of the recording conditions CT1 to CT4, it is understood that the condition CT4 provides a PRSNR of around 32 which is superior. However, upon evaluation based on the transient equalization error (FIG. 19) under the condition CT4 the signal qualities, such as the absolute value of the transient equalization error, balance of the error with respect to the reference (target), average value and the integrated value, it is concluded that the calibration was insufficient.

The optical information recording/reproducing unit, upon judging that calibration of the recording condition is insufficient, performed recording under the recording condition CT5 while further changing the laser pulse shape, and reproduced the recorded area similarly to the case as described above, to measure (calculate) the transient equalization error, average value Ave, and integrated value SUM corresponding to the front edge and rear edge of the mark or space of 2T pattern, 3T pattern, and the 4T or longer pattern.

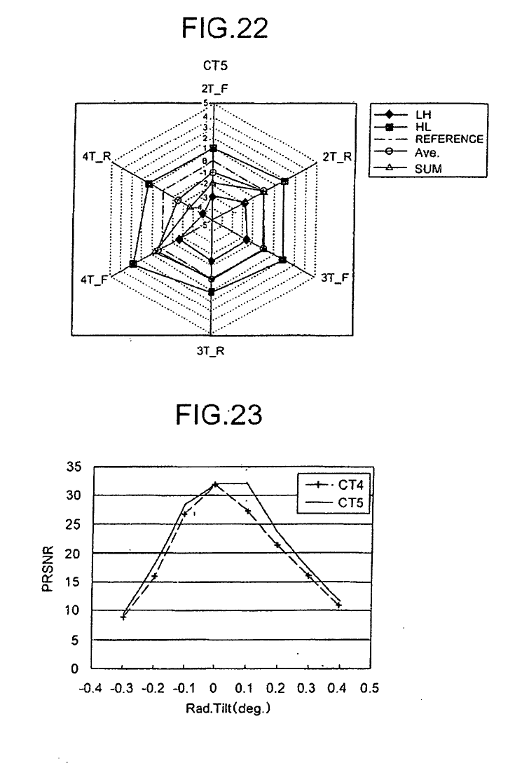

FIG. 21 shows the results of measuring the PRSNR in the condition CT 5 that is added to the results of measurement of the PRSNR shown in FIG. 20. FIG. 22 shows the results of measuring the transient equalization error, average value Ave, and integrated value SUM corresponding to the front edge and rear edge of the mark or space of each pattern under the condition CT5. With reference to FIG. 21, there is no significant difference in the value of PRSNR between the condition CT4 and the condition CT5. However, comparing the condition CT4 of FIG. 19 against FIG. 22 (condition CT5), employment of the condition CT5 improves the transient equalization errors, especially the transient equalization error of 2T pattern, whereby a transient equalization error more close to the target can be obtained. The controller 50 set the recording condition parameters of the suitable recording condition CT5 derived in this way onto the LD drive circuit 13.

In order to verify the validity of the above calibration, a margin of the conditions CT4 and CT5 was measured on the tilt of the optical head upon recording in the radial direction with respect to the optical disc. FIG. 23 shows the tilt-dependent characteristic under the condition CT4 and condition CT5. More specifically, recording/reproducing while changing the tilt and measuring the PRSNR at each tilt provided the results of measurement shown in FIG. 23. With reference to FIG. 23, although the maximum (peak) of PRSNR is comparable between the condition CT4 and the condition CT5, a larger change of PRSNR was caused by different amounts of tilt in the condition CT4, to thereby reveal narrower margin therein. On the other hand, it was revealed that a large margin with respect to the tilt can be obtained in the condition CT5, whereby the validity of the calibration using the transient equalization error was assured.

### EXAMPLE 2

The optical information recording/reproducing unit used in this example was the same as that used in the first example, and had a NA of 0.65 for the objective lens, and a LD wavelength, λ, of 405 nm. The optical disc used was one having a substrate thickness of 0.6 mm, and a bit pitch of 0.13 μm and a track pitch of 0.34 μm as the recorded data density. The recording film of the optical disc used was a phase-change recording film that performs recording based on the phase change thereof, and thus is of a rewritable type. The recording/reproducing data on the optical disc was performed by the ECC. The configuration was such that the signal-quality detector used herein was the signal-quality detector 40 in the first exemplary embodiment, “4” is employed as the specific level-value in the signal-quality detector 40, and the transient-equalization-error detector 44 calculated the transient equalization error of the 2T pattern.

The controller 50, upon loading of the optical disc onto the optical information recording/reproducing unit, judged the type of optical disc, set the waveform which was calibrated in advance for record compensation, moved the PUH 10 to the specific position, and performed recording while changing the recording power. The controller 50 then reproduced the recorded mark, and performed selection of a suitable power based on the transient equalization error. A recording power was obtained that causes the total value of the transient equalization error (transient equalization error calculated for the mark and space and for the front edge and rear edge and obtained without classification) to approach zero (target), wherein a laser power of Pw=1 was selected as the suitable recording power.

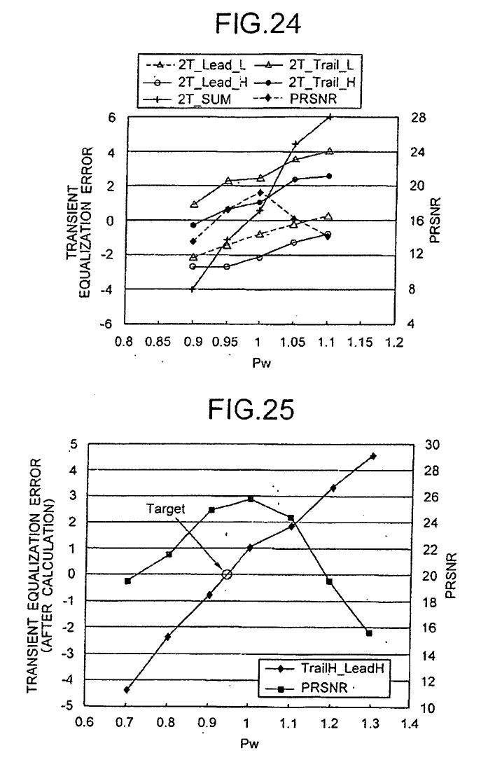

FIG. 24 shows the relationship between the recording power and the transient equalization error that corresponds to the 2T pattern and PRSNR. FIG. 24 additionally shows the transient equalization errors of the mark (_L) and space (_H), and the front edge and rear edge corresponding to the 2T pattern, that are obtained using classification. With reference to the same drawing, it was confirmed that the power that causes the transient equalization error (SUM) corresponding to the 2T pattern to be closest to zero corresponds to the recording power that causes the PRSNR to assume the optimum value, and that the recording parameters are thus calibrated with a higher degree of accuracy.

In the present example, the transient equalization error was calculated by the signal-quality detector 40 shown in FIG. 3 without classification of the mark or space, and the front edge and rear edge; however, the transient equalization error may be calculated while classifying them. In the case of calculation while classifying the mark or space as well as the front edge and rear edge, it is possible to judge which direction and how far the position of the mark or space is deviated from the target. However, since the setting used in the present example is one that was calibrated in advance, it is not needed to classify the positional deviation of the edge between the mark and the space and between the front edge and the rear edge, whereby the signal-quality detector 40a having the configuration shown in FIG. 9 is sufficient. In addition, if the correlation between the performance, such as the PRSNR and amount of error, and the transient equalization error under the specific condition, such as for the front edge of the 2T pattern, is calibrated in advance, calibration of the recording condition (recording power) can be achieved by using only the transient equalization error of the specific condition (front edge of the 2T mark).

### EXAMPLE 3

The optical information recording/reproducing unit used in the present example was the same as that used in the first example. The optical disc used herein had a bit pitch of 0.13 μm and a track pitch of 0.34 μm as the data density for recording, and included a phase-change recording film that performs recording by the phase change thereof. The optical disc used in the present example was a disc of a rewritable type (HLRW disc), wherein recording of the mark reduces the reflectance. Recording/ reproduction of data is performed by the ECC. The signal-quality detector used herein was a type of the signal-quality detector 40a used in the second exemplary embodiment and shown in FIG. 9, wherein the signal-quality detector 40a calculated the transient equalization errors classified between the front edge and the rear edge of the 2T pattern.

FIG. 25 shows the relationship between the power ratio and the transient equalization error (after calculation) that corresponds to the difference between the front edge and the rear edge of 2T as well as the PRSNR. The power ratio plotted on the abscissa is the ratio of power assumed in advance for the respective types and manufacturers of the discs. More specifically, if the recording power calibrated in advance is 7 mW for a rewritable medium of a specific manufacturer, a recording power of 7 mW corresponds to the power ratio of 1. The transient equalization error (after calculation) is the difference between a transient equalization error of the front edge and a transient equalization error of the rear edge both of the 2T, and defined by a difference (rear edge side minus front edge side). The correlation between the power ratio and the transient equalization error (after calculation) is obtained in advance and stored in the unit.

The controller 50, upon loading of the optical disc onto the optical information recording/reproducing unit, judged the type of the optical disc and recognized the same as the HLRW disc. The optical information recording/reproducing unit read out the correlation shown in FIG. 25, set the waveform obtained in an advance for calibration of the record compensation, then moved the PUH 10 to the specific position of the optical disc, and performed recording in the area of four ECCs with a constant recording power. Thereafter, the controller 50 reproduced the recorded marks, calculated the transient equalization error of the front edge and rear edge corresponding to the 2T pattern, and obtained the difference therebetween, which revealed “2”. With reference to FIG. 25, the transient equalization error (after calculation) equal to 2 is equivalent to the recording at a power ratio of 1.1.

The controller 50 obtains which power ratio the recording corresponds, thereafter sets the recording power so that the recording is performed at a power ratio (0.95) that is the target position shown by o in FIG. 25, causes the transient equalization error (after calculation) to assume zero, and ends the calibration. More specifically, the recording power is set at P1×(0.95/1.1), with the recording power used for the recording being P1. Recording and reproduction was performed thereafter for assuring the results of calibration, wherein the transient equalization error (after calculation) assumed 0.05. In this way, it was confirmed that an accurate calibration can be obtained even if the calibration is performed using the results of an advance calibration.

### EXAMPLE 4

The optical information recording/reproducing unit used in the present example was the same as that used in the first example. The optical disc used herein was a write-once disc having a substrate thickness of 0.6 mm, a bit pitch of 0.153 μm and a track pitch of 0.4 μm as the density for recorded data, and including an organic dye for the recording film. The signal-quality detector used herein is the signal-quality detector 40a in the second exemplary embodiment shown in FIG. 9, wherein the signal-quality detector 40a calculated the transient equalization errors that are classified between the front edge and the rear edge of each of the 2T, 3T and 4T or longer patterns. In the present example, it was confirmed whether the controller 50 (FIG. 1) can secure the performance by adaptively changing and calibrating the recording pulse shape while detecting the transient equalization errors.

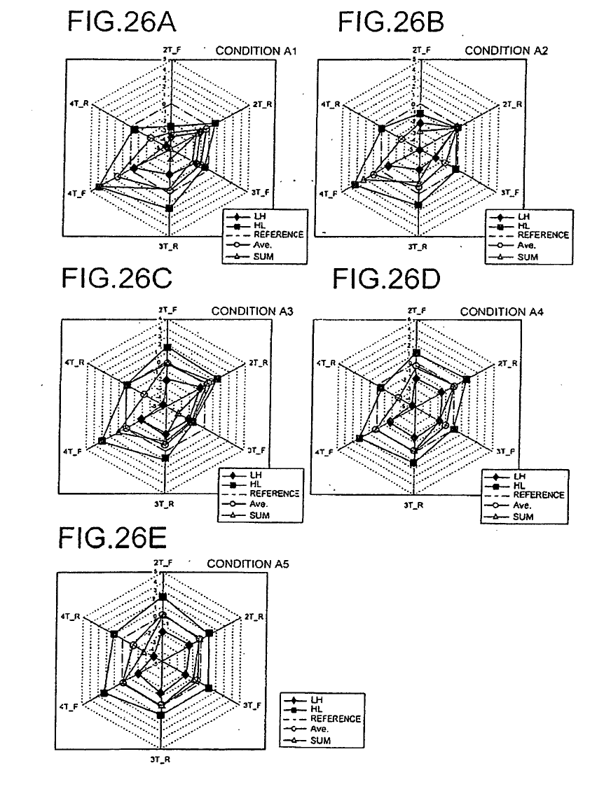

FIGS. 26A to 26E show the transient equalization errors at the front edge and rear edge of the mark or space under each of the calibrating conditions used for measuring the transient equalization errors while adaptively changing the recording condition (calibration condition of the pulse shape). The optical information recording/reproducing unit stores therein a conversion table showing the correspondence relationship between the state of mark shape recognized by the controller and the corresponding operation thereof, and refers to the correspondence relationship to execute the operation corresponding to the state of mark shape recognized based on the transient equalization error, to adaptively adjust the calibration condition of the pulse waveform. The Table 2 shown below comprehensively shows the state recognized by the controller, countermeasure for responding to the state, correction of the recording condition actually transferred from the controller to the LD drive circuit 13 (FIG. 2), and results of measurement of PRSNR in the calibration condition after the correction. It is assumed here that calibration of the recording power has been already completed prior to calibration of the pulse shape.

The recording is first performed under the calibration condition A1, and the data is then reproduced to calculate the transient equalization error. The transient equalization errors obtained at the front edge and rear edge of the mark and space of each pattern are those shown in FIG. 26A. The controller 50 recognizes that the 2TF is a negative value based on the transient equalization error, and reads out, as the countermeasure, the operation for turning the 2TF into a positive value from the conversion table. The controller 50 adjusts (corrects) the 2T space that is behind each of all the marks, and performs recording under the corrected condition (calibrated condition A2). The data recorded under the corrected condition A2 is then reproduced to measure the PRSNR, which revealed 26.2.

The controller 50 refers to the transient equalization error (FIG. 26B) under the condition A2, to recognize that the 2TF and 2TR do not cross zero, and executes the operation for increasing the 2T as the countermeasure. The controller 50 sets the calibration condition (calibration condition A3) that changes the front edge position of the 2T to thereby expand the time width of the 2T-recording pulse, and performs recording under the condition A 3. The data recorded under the corrected condition A3 was reproduced to measure the PRSNR, which revealed 34.

The controller 50 recognizes that the 2T is turned into a positive value with reference to the transient equalization error under the condition A3 (FIG. 26C), and then shifts to calibration of 3T. Since the condition A3 causes the value of 3TF to assume a negative value, a countermeasure for turning the 3TF into a positive value is to be implemented. The controller 50 sets a condition (calibration condition A4) that changes the front edge 3Tsfp to thereby expand the 3T time width, Δ, and performs recording under the condition A4. The data recorded under the condition A4 was reproduced to measure the PRSNR, which revealed 35.5.

The controller 50 recognizes that the 3T is turned into a positive value with reference to the transient equalization error under the condition A4 (FIG. 26D), and then shifts to calibration of 4T (4T or longer). Since the condition A4 causes only the value of 4TR to be smaller, a countermeasure for turning the 4TR into a larger value is to be implemented. The controller 50 sets a condition (calibration condition A5) that enlarges the rear edge of the recording pulse for the 4T or longer, and performs recording under the condition A5. The data recorded under the condition A5 was reproduced to measure the PRSNR, which revealed 39.

The controller 50 recognizes that there is no trouble state, with reference to the transient equalization error (FIG. 26E) under the condition A5, and ends calibration of the recording condition. The PRSNR had a value 26.2 at the initial stage of calibration, and shifted finally to a value of 39, thereby revealing that the adaptive calibration of the recording condition based on the transient equalization condition can improve the PRSNR.

TABLE 2

| | State of formed mark | | |
|---|---|---|---|
| | recognized by Controller | Operation | |
| | and Countermeasure operation | performed by | |
| Condition | (State/Countermeasure) | Controller | PRSNR |
| A1 | 2TF: negative/Turn 2TF | Calibrate 2T | 26.2 |
| | positive | space behind | |
| | | each of all marks | |
| A2 | 2TF/R do not cross | Change front edge | 34.0 |
| | zero/Enlarge 2T | of 2T to enlarge | |
| | | time width Δ of | |
| | | 2T-recording pulse | |
| A3 | 2T turned to positive. | Change front edge | 35.5 |
| | 3T space turned to | 3Tsfp to enlarge | |
| | negative./Turn 3TF positive | time width Δ of 3T | |
| A4 | Only 4TR is | Enlarge rear edge | 39.0 |
| | small/Enlarge 4TR | of Recording pulse | |
| | | for 4T or longer | |
| A5 | End of calibration | | |

It is known that the PRSNR should assume around 20 or above including the device margin. The PRSNR already exceeds 25 at the initial stage of calibration, and thus there is substantially no trouble on the reproduction even without changing the PRSNR. However, the total device margin is likely to be reduced due to a variety of factors in the case of handling a large number of devices. Thus, as shown in the present example, it is highly desirable that the respective margins have a sufficient excessive margin. The validity of the present example could be assured by the capability of improving the PRSNR up to a value of 39, even in the case where the PRSNR already exceeds 25, by later calibrating the pulse waveform parameters of the respective patterns based on the transient equalization error.

### EXAMPLE 5

The optical information recording/reproducing unit used in the present example had a NA of 0.65 for the objective lens in the optical head and a LD wavelength, λ, of 405 nm, similarly to the first example. The optical disc used herein was a write-once disc having a substrate thickness of 0.6 mm, a bit pitch of 0.153 μm and a track pitch of 0.4 μm as the data density for recording, and including an organic dye in the recording film. The optical information recording/reproducing unit included a storage section 80 (FIG. 4, FIG. 5) that stores therein a recording data train, and was configured to generate a reference reproduced-waveform with reference to the storage section 80. The storage section 80 used herein was a 2-MB semiconductor memory device. The signal-quality detector used herein was the signal-quality detector 40a in the second exemplary embodiment shown in FIG. 9, wherein the signal-quality detector 40a was configured to calculate the transient equalization errors of the front edge and rear edge of the 2T pattern.

The optical information recording/reproducing unit, upon loading of the optical disc thereto, read out the identification information of the manufacturer of the thus loaded optical disc and judged that the disc was one manufactured by the disc manufacturer A. The optical information recording/reproducing unit moved the PUH 10 (FIG. 4) to a drive test zone of the optical disc so as to calibrate the recording power and detected an area including no mark recorded therein. Thereafter, the optical information recording/reproducing unit performed recording on the five ECC blocks by the ECC block as a unit while changing the recording power in a stepwise fashion around the central recording power used for the manufacturer A and stored in the optical information recording/reproducing unit. The optical information recording/reproducing unit then reproduced the recorded area to measure the transient equalization error as the reproduced signal quality.

The recorded pattern recorded in the drive test zone was such that the seed of M-sequence belongs to the same random pattern. The random pattern recorded in the ECC blocks is the same pattern. The recorded pattern is saved in the storage section 80. The reference-waveform generation unit 42 (FIG. 5) reads out the recording data train from the storage section 80, to generate a reference reproduced-waveform. The reference-waveform generation unit 42 loads the recording data train from the storage section 80 based on the recording-data-load timing signal generated by the timing control circuit 41 based on a synchronizing-pattern detection detected by the timing detection circuit (not shown) detecting the output of the equalizer.

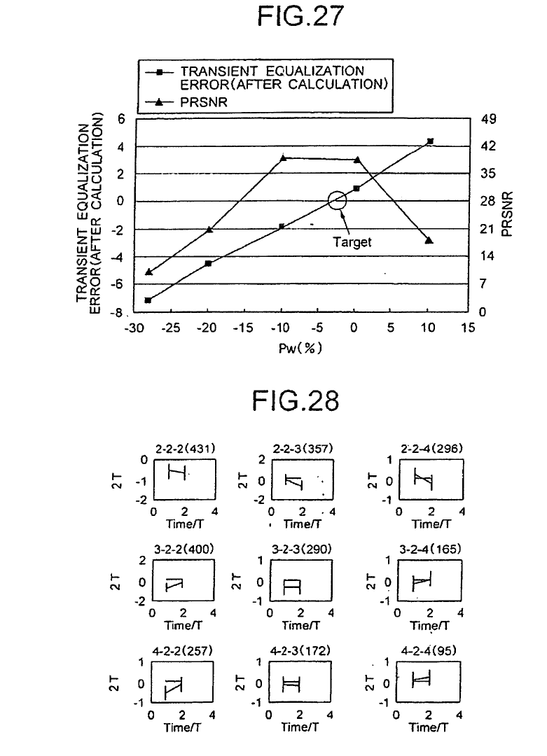

FIG. 27 shows the relationship between the power and the transient equalization error (after calculation) that is the difference between the rear edge and the front edge corresponding to the 2T. When the area in which the recording is performed while changing the power is subjected to reproduction to obtain the transient equalization error (after calculation) corresponding to the 2T, the transient equalization error (after calculation) measured with respect to the power is such that plotted by ▪. The unit calculated a suitable power that allows the transient equalization error (after calculation) to assume zero (target) and is equal to minus 2.5%, (i.e., 2.5% less than the power that is read out at the initial stage as the power of manufacturer A). FIG. 27 additionally shows the relationship between the power for the disc of manufacturer A and the PRSNR, wherein the PRSNR exceeds 35 at a power of −2.5%. Thus, it was confirmed that recording at a power (−2.5%) selected in the present example allows sufficient suppression of the error in the recording, to reveal the validity of the calibration.

### EXAMPLE 6

The optical information recording/reproducing unit used in the present example had a NA of 0.65 for the objective lens in the optical head and a LD wavelength, λ, of 405 nm, similarly to the first example. The optical disc used herein was a write-once disc having a substrate thickness of 0.6 mm, and a bit pitch of 0.153 μm and a track pitch of 0.4 μm as the density of recorded data, and included an organic dye in the recording film. The signal-quality detector used herein was the signal-quality detector 40b in the third exemplary embodiment shown in FIG. 11, wherein the signal-quality detector 40b calculated the transient equalization errors that are classified for the respective mark lengths preceding or succeeding to each pattern. Recording and reproduction is performed by ECC block.

The controller 50 (FIG. 1), upon loading of an optical disc onto the optical information recording/reproducing unit, recognized the type of the optical disc, set the waveform calibrated in advance for the record compensation, moved the PUH 10 to the specific position, and performed recording using the information stored in the unit in advance. The recorded area is then subjected to reproduction to measure the PRSN, which revealed around 20. This value had a performance below the performance of the information (PRSNR=23) provided in the unit, and the controller 50 judged an insufficient calibration. Thus, a detailed calibration of the recording parameters was performed using the level-group recognition unit 46 (FIG. 11).

FIG. 28 shows the results of measuring the transient equalization errors of the 2T mark. Prior to the detailed calibration, the recorded area was subjected to reproduction to calculate the transient equalization errors classified for the respective mark lengths preceding or succeeding to the 2T mark, and the results of calculation are shown in FIG. 28. In FIG. 28, ordinate represents the transient equalization error, and abscissa represent the time axis. The notation 3-2-3 means such that the transient equalization error thus calculated is one for the series of 3T space, 2T mark and 3T space, whereas the number between parentheses is the number of samples used.

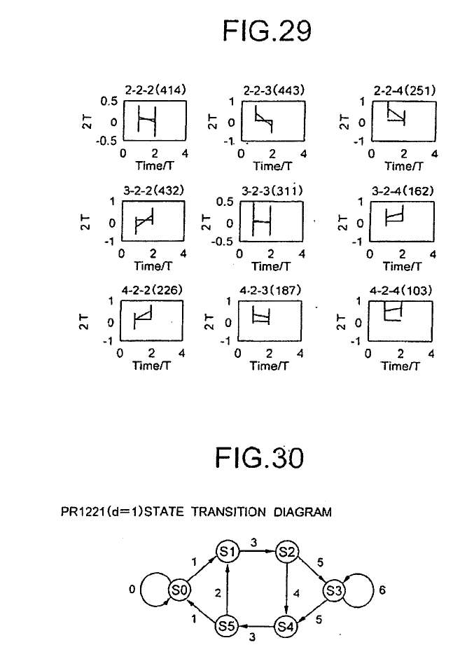

With reference to FIG. 28, it is understood that the transient equalization error has a deviation relative to the reference (0) especially in the 2T and 3T that are shorter patterns. The controller 50 changed the shape and timing of the recording pulse waveform based on this information so that the transient equalization error selectively decreases and the integral of the front edge and rear edge approaches zero, for performing a trial calibration. Measurement of the PRSNR after this calibration revealed 22 for the PRSNR, thereby showing the improvement of the PRSNR. FIG. 29 shows the results of measurement of the transient equalization errors after the calibration. Comparing the same against FIG. 28 showing such prior to calibration, it is understood that the balance of the front edge and the rear edge with respect to the reference is improved for the short patterns, thereby revealing the validity of the this method.

As described heretofore, according to the present invention, it is possible to detect, with a higher degree of accuracy, the positional deviation of the recorded mark recorded with a higher density, whereby formation of a higher-quality recorded mark having a larger margin can be achieved. Upon calibration of the recording condition, it is possible to achieve the advantage of a higher-speed calibration without involving waste of the calibration area. The present invention also provides a method of measuring the signal quality of the recorded mark suitable for a higher-density recording/reproduction, thereby allowing formation of the recorded mark more suitable for the higher-density recording/reproduction.

The reproduction/detection technique for a high-density-recorded mark as typified, in particular, by the PRML may include a conventional level-slice detection technique. Thus, it is apparent that the technique of the present invention can be applied to the PRML detection technique even if it is applied to such a recording density that allows detection by the level-slice detection technique. The NA related to the beam diameter in the configuration of the optical head is not limited to 0.65, and the present invention may be applied as well to a system having a NA of 0.85 and thus forming a smaller recorded mark.

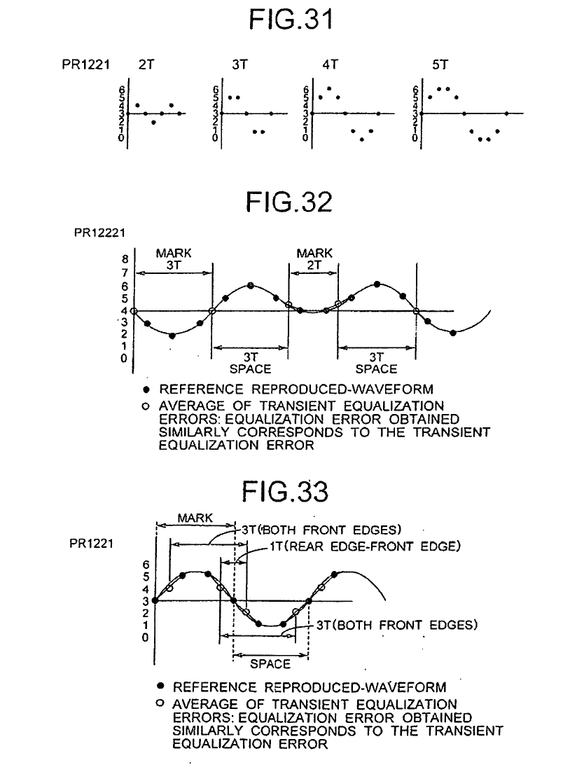

In the above description, the PR12221 is exemplified; however, quality measurement of the recorded mark and calibration of the recording condition can be performed in a similar way for other PR classes. Hereinafter, a case will be described where PR 1221 is used. FIG. 30 shows a signal transition diagram wherein the way of signal transition is shown for the case of reproducing a recorded mark train, which is formed by (1,7) RLL, by using the PR (1,2,2,1) equalization. FIG. 31 shows the reference reproduced-waveform for the 2T to 5T. The 6T or above is such that the level-value thereof at “0” and “6” is prolonged from the 5T by the number of clocks as the units, and thus is omitted for description.

In the PR12221, the reference reproduced-waveform is classified into nine levels (FIG. 7). With reference to FIGS. 30 and 31, the level in the PR1221 assumes seven level-values, “0” to “6”. The level in the PR12221 does not assume the central level-value, “4”, except for 2T. On the other hand, it will be understood that the level in the PR1221 assumes the central level-value, “3”, without fail upon transition from the mark to space or from the space to mark.

In the case of PR1221, the transient equalization error is calculated at the specific level-value, for example, the central level-value “3” selected from among the levels of “0” to “6”. More specifically, among the equalization errors that are obtained as the difference between the reproduced signal waveform and the reference reproduced-waveform, an equalization error obtained at the level “3” upon transition of the level thereto from another level at one or two channel clocks before or upon transition of the level therefrom to another level at one or two channel clocks after is selected as the transient equalization error. The following table 3 shows the transient equalization errors at the front edge and rear edge of each mark length or space length, similarly to table 1.

TABLE 3

| | Specific | Transition of | Transition |
|---|---|---|---|
| | Value | Level | Equalization Error |
| Front Edge of 2T | 3 | 4→3 | Front Edge of 2T Mark (LH |
| | | | 2TF) |
| | 3 | 2→3 | Front Edge of 2T Space (HL |
| | | | 2TF) |
| Rear Edge of 2T | 3 | 3→4 | Rear Edge of 2T Mark (LH |
| | | | 2TR) |
| | 3 | 3→2 | Rear Edge of 2T Space (HL |
| | | | 2TR) |
| Front Edge of 3T | 3 | 5→5→3 | Front Edge of 3T Mark (LH |
| | | | 3TF) |
| | 3 | 1→1→3 | Front Edge of 3T Space (HL |
| | | | 3TF) |
| Rear Edge of 3T | 3 | 3→5→5 | Rear Edge of 3T Mark (LH |
| | | | 3TR) |
| | 3 | 3→1→1 | Rear Edge of 3T Space (HL |
| | | | 3TR) |
| Front Edge of 4T | 3 | 6→5→3 | Front Edge of 4T or Longer |
| or Longer | | | Mark (LH 4TF) |
| | 3 | 0→1→3 | Front Edge of 4T or Longer |
| | | | Space (HL 4TF) |
| Rear Edge of 4T | 3 | 3→5→6 | Rear Edge of 4T or Longer |
| or Longer | | | Mark (LH 4TR) |
| | 3 | 3→1→0 | Rear Edge of 4T or Longer |
| | | | Space (HL 4TR) |

As described before, as to the correspondence of the mark and space, optical information recording media include one wherein the reflectance changes from low to high along with a change from a non-recorded state to a recorded state, and another wherein, to the contrary, the reflectance changes from high to low along with a change to a recorded state. Although the correspondence of the mark and space may be reversed depending on the medium used therein, this can be handled by suitably changing the signal processing etc. depending on the type of the medium.

As to 2T in the PR1221, the front edge and rear edge can be distinguished based on the transition from the level at one channel clock before or after; however, as to 3T and 4T (or above), the level transition may be same as the transition at one channel clock before or after, unlike the PR12221. For example, for both the front edge of 3T (LH 3TF) and front edge of 4T (or above) (LH 4TF), the level ahead the level “3” is level “5”. The transition of HL 3TF and HL 4TF, the transition of LH3TR and LH 4TR and the transition of HL 3TR and HL4TR are the same for each two, similarly to the above case. Thus, the level at two channel clocks before or after is used herein for classifying the each two. The “level at two channel clocks before” as to the LH 3TR is “5” and that as to the LH 4TF is “6”. Therefore, if the transition advances 5→5→3, LH 3TF is recognized, whereas if the transition advances 6→5→3, LH 4TF is recognized. As to the other cases, observation of the transition within two channel clocks before or after provides recognition of the front edge and rear edge of 3T and 4T (or above).

Next, the difference in the interval of the transient equalization error depending on the difference in the PR class will be described. In the PR 1221, since the transition from the mark to space and from the space to mark involves the central level “3” without fail, the timing of detection of all the transient equalization errors uses the transition equalization error at the timing of level “3”. For this reason, the front edge of “aT” is the same as the rear edge of “bT”, and the rear edge of “aT” is the same as the front edge of “cT” (a, b, and c are each integer equal to 2, 3, 4 or above). That is, the front edge and rear edge in the PR 1221 are in a strong association with each other. The overlapping of the calculation timing of the transient equalization error between the front edge and the rear edge renders the interval between adjacent transient equalization errors equal to the interval corresponding to the recorded length. For example, in the 3T mark, the transient equalization error corresponding to the rear edge is obtained at three channel clocks after the transient equalization error corresponding to the front edge thereof.

On the other hand, in the PR 12221, the transient equalization errors are classified into six transient equalization errors corresponding to the front edge and rear edge of 2T, front edge and rear edge of 3T, and front edge and rear edge of 4T or longer, and the patterns other than 2T pattern do not assume the central level “4”, and have respective independent levels. More specifically, the PR 12221 allows the front edges and rear edges to be independent from one another. As described before, since the same level (level “3”) is used in the PR 1221 for both the mark and space, the transient equalization errors thereof are in association with one another, whereas since different levels are used in the PR12221 for the mark and space, the transient equalization errors thereof are independent from one another. In any of these transient equalization errors, the improvement of performance can be obtained by adjusting the deviation (balance) of the transient equalization errors with respect to the target.

Independent transient equalization errors may also be used in the PR1221, or transient equalization errors in association with one another may also be used in the PR12221. Although the six transient equalization errors in the PR12221 are independent between the front edge and the rear edge, with one channel clock disposed therebetween, a value of (front edge+rear edge)/2 may be used for the transient equalization error, to obtain mutual association between the transient equalization errors. FIG. 32 shows the concrete situation. Considering the transition from the 3T mark to 3T space in FIG. 32, the rear edge of the 3T mark assumes level “3”, whereas the front edge of the 3T space assumes level “5”. The average of transient equalization errors at these time instants corresponds to the transient equalization error at the central level “4”.

Next, considering the transition from the 2T mark to the 3T space in FIG. 32, the rear edge of the 2T mark assumes level “4” whereas the front edge of the 3T space assumes level “5”. In this case, the average of these transient equalization errors, if obtained, provides the transient equalization errors in association with one another, which corresponds to the transient equalization error having an intermediate value between the level “4” and the level “5”. Thus, if the 2T is concerned to the transient equalization error, the resultant transient equalization error is deviated from the central level “4”, and the average interval of the transient equalization error thus obtained corresponds to the interval of the n channel clocks as a unit. This procedure provides six transient equalization errors in association with one another in the PR12221, similarly to the PR1221.

In the PR1221, the equalization error obtained at the level “3” and the equalization error at one channel clock before or after may be averaged to obtain a transient equalization error, and six independent transient equalization errors may be obtained in this way. FIG. 33 shows the concrete situation. The transition from the 3T mark to the 3T space is considered with reference to FIG. 33. The level at one channel clock before the level “3” at the rear edge of the 3T mark assumes “5” whereas the level at one channel clock after the level “3” at the front edge of the 3T space assumes “1”. In this case, the average of the equalization error at the level “3” and the equalization error at the level “5” is determined as the transition corresponding to the rear edge of the 3T mark. In addition, the average of the equalization error at the level “3” and the equalization error at the level “1” is determined as the transition equalization error corresponding to the front edge of the 3T space. In this way, the transition equalization error corresponding to the rear edge of the mark is affected by the mark in a larger degree, whereas the transient equalization error corresponding to the front edge of the space is affected by the space in a larger degree.

As described above, use of the six transient equalization errors in association with one another the PR1221 and use of the six independent transient equalization errors will also improve the performance, so long as the importance of balance is considered.

The present invention achieves the advantages as described hereinafter.

An optical information recording/reproducing unit according to a preferred embodiment of the present invention calculates, as a transient equalization error, a difference between the reference reproduced-waveform and the reproduced signal waveform at a time instant at which the reference reproduced-waveform assumes a specific level-value and at which the specific level-value and a level-value group at m channel clocks (m is an integer not less than one) before or after the time instant of the specific level-value satisfy therebetween a specific relationship. For example, with the specific level-value being assumed at “4”, a difference between the reference reproduced-waveform and the equalized reproduced waveform at the time instant of transition from another level-value to the level-value “4” or at the time instant of transition from the level-value “4” to another level-value and the reference reproduced-waveform is calculated as the transient equalization error. The transient equalization error obtained in this way assumes a value corresponding to the positional deviation of the recorded mark, and thus can be used as a quality index of the positional deviation of the recorded mark. Since the positional deviation of the recorded mark is detected by a technique suitable to the higher-density recording in the optical information recording/reproducing unit of the present invention, the positional deviation of the recorded mark formed with a higher-density recording technique can be detected with a higher degree of accuracy.

A method for measuring a recorded mark quality of an optical information recording-reproducing unit according to a preferred embodiment of the present invention calculates, as a transient equalization error, a difference between the reference reproduced-waveform and the reproduced signal waveform at a time instant at which the reference reproduced-waveform assumes a specific level-value and at which the specific level-value and a level-value group at m channel clocks (m is an integer not less than one) before or after the time instant satisfy therebetween a specific relationship. Since the method of measuring the recorded mark quality of the present invention detects the positional deviation of the recorded mark by using a technique suited to a higher-density recording, the positional deviation of the recorded mark recorded with a higher density on the medium can be detected with a higher degree of accuracy.

A record controlling method according to a preferred embodiment of the present invention calculates, as a transient equalization error, a difference between the reference reproduced-waveform and the reproduced signal waveform at a time instant at which the reference reproduced-waveform assumes a specific level-value and at which the specific level-value and a level-value group at m channel clocks (m is an integer not less than one) before or after the time instant satisfy therebetween a specific relationship, and controls the shape of a recording laser pulse that irradiates the optical information recording medium upon data recording so that the transient equalization error decreases. The transient equalization error represents the quality of the recorded mark formation, and control of the recording condition by using the transient equalization error so as to improve the quality of recorded mark allows superior recording/reproduction.

The following description comprehensively discloses the preferred embodiments of the present invention.

The optical information recording/reproducing unit according to the present invention may employ a configuration wherein the reference-waveform generation section generates the reference reproduced-waveform by applying the specific response characteristic to an estimated data train estimated based on the reproduced signal waveform. In an alternative, a configuration may be employed wherein the reference-waveform generation section reads out a recording data train recorded on the optical information recording medium from a storage unit, and generates the reference reproduced-waveform by applying the specific response characteristic to the recording data train. A configuration may be employed wherein a recording data train corresponding to the reproduced signal waveform is estimated based on the reproduced signal waveform and used upon generation of the reference reproduced-waveform. In an alternative, a configuration may be employed wherein the data recorded on the medium is stored in a storage section and the reference reproduced-waveform is generated with reference thereto.

The optical information recording/reproducing unit according to the present invention may employ a configuration wherein the reproduced signal waveform and the reference reproduced-waveform are each continuous waveform that has a level-value at each channel clock corresponding to the recorded mark or space recorded on the optical information recording medium.

The optical information recording/reproducing unit according to the present invention may further includes a level-value recognition section that judges, based on a level-value of the reference reproduced-waveform or a transition of the level-value of the reference reproduced-waveform, which of the recorded mark and space or which of a front edge and a rear edge on the optical information recording medium the level-value of the reference reproduced-waveform corresponding to the time instant at which the transient equalization error is obtained corresponds, and may have a configuration wherein the transient-equalization-error calculation section classifies the transient equalization error based on results of the recognition by the level-value discrimination section. In this case, since the level-value recognition section judges whether the specific level-value at the time instant of calculating the transient equalization error corresponds to the mark or space, the transient equalization error can be specified as the mark or space. In addition, by judging whether the transition is a transition from the specific level-value or a transition to the specific level-value, the transient equalization error can be classified corresponding to the front edge and the rear edge of the mark or space.

The optical information recording/reproducing unit according to the present invention may further include level-group recognition section that stores therein a level transition pattern within of a plurality of channel clocks before and/or after the time instant at which the reference reproduced-waveform assumes the level-value, as a level group corresponding to a mark or space having a specific recorded length, and judges based on the level group which of a mark and a space the level-value of the time instant at which the transient equalization error is obtained corresponds, and may have a configuration the transient-equalization-error calculation section classifies the transient equalization error based on a result of judgment by the level-group recognition section. In this case, classification of the transition into detailed classification by using the level group allows the transient equalization error to be classified into combinations of the mark and space having a variety of recorded length.

The optical information recording/reproducing unit according to the present invention may employ a configuration wherein the transient-equalization-error calculation section calculates at least one of a transient equalization error corresponding to a shortest mark or space on the optical information recording medium or another mark or space that is one channel clock longer than the shortest mark or space, and a transient equalization error corresponding to a front edge or rear edge of the shortest mark or space or the another mark or space that is one channel clock longer than the shortest mark or space.

The optical information recording/reproducing unit according to the present invention may further includes a recording-condition control section that controls the shape of a recording laser pulse that irradiates the optical information recording medium upon data recording so that the transient equalization error decreases. By using the transient equalization error as the quality index showing the quality of the recorded mark formation to set the recording condition so as to improve the quality of recorded mark formation, superior recording/reproduction can be obtained.

The optical information recording/reproducing unit according to the present invention may employ a configuration wherein the recording-condition control section controls the shape of the recording laser pulse by changing at least one of a starting position or ending position and a waveform shape of the recording laser pulse for each recording mark, to thereby change a position of the recorded mark or space, so that the transient equalization error decreases. By performing recording while changing the recording condition, reproducing the recorded data to obtain the transient equalization error and adaptively calibrating the recording condition so as to reduce the thus obtained transient equalization error, a recording condition allowing a superior recording/reproduction can be obtained.

The method for measuring a recorded-mark quality of an optical information recording medium according to the present invention may employ a configuration wherein the reference-waveform generating reads out a recording data train recorded on the optical information recording medium from a storage unit, and generates the reference reproduced-waveform by applying the specific response characteristic to the recording data train.

The method for measuring a recorded-mark quality of an optical information recording medium according to the present invention may employ a configuration wherein the reproduced signal waveform and the reference reproduced-waveform are each continuous waveform that has a level-value at each channel clock corresponding to the recorded mark or space recorded on the optical information recording medium.

The method for measuring a recorded-mark quality of an optical information recording medium according to the present invention may further includes: judging, based on a level-value of the reference reproduced-waveform or a transition of the level-value of the reference reproduced-waveform, which of the recorded mark and space or which of a front edge and a rear edge on the optical information recording medium the level-value of the reference reproduced-waveform corresponding to the time instant at which the transient equalization error is obtained corresponds, and classifying the transient equalization error based on a result of the recognition in the judging. In this case, since it is judged whether the specific level-value at the time instant of calculating the transient equalization error corresponds to the mark or space, the transient equalization error can be specified as the mark or space. In addition, by judging whether the transition is a transition from the specific level-value or a transition to the specific level-value, the transient equalization error can be classified corresponding to the front edge and the rear edge of the mark or space.

The method for measuring a recorded-mark quality of an optical information recording medium according to the present invention may further includes: storing a level transition pattern within of a plurality of channel clocks before or after the time instant at which the reference reproduced-waveform assumes the level-value, and judging, based on a level group corresponding to a mark or space having a specific recorded length, which of a mark and space the level-value of the time instant at which the transient equalization error is obtained corresponds; and classifying the transient equalization error based on a result of judgment in the judging. In this case, classification of the transition into detailed classification by using the level group allows the transient equalization error to be classified into combinations of the mark and space having a variety of recorded length.

The method for measuring a recorded-mark quality of an optical information recording medium according to the present invention may employ a configuration wherein the transient-equalization-error calculating calculates at least one of a transient equalization error corresponding to a shortest mark or space on the optical information recording medium or another mark or space that is one channel clock longer than the shortest mark or space, and a transient equalization error corresponding to a front edge or rear edge of the shortest mark or space or the another mark or space that is one channel clock longer than the shortest mark or space.

The record controlling method for an optical information recording medium according to the present invention may further include controlling the shape of the recording laser pulse by changing at least one of a starting position or ending position and a waveform shape of the recording laser pulse for each recording mark, to thereby change a position of the recorded mark or space, so that the transient equalization error decreases.

According to the optical information recording/reproducing unit, method for measuring the quality of recorded mark on an optical information recording medium and the recording control method of the present invention, calculation of the difference between the reference reproduced-waveform and the reproduced signal waveform at a time instant at which the reference reproduced-waveform assumes a specific level-value and at which the specific level-value and a level-value (level-value group) at m channel clocks (m is an integer not less than one) before or after the time instant of the specific level-value satisfy therebetween a specific relationship is performed to obtain the transient equalization error. This transient equalization error can be used as a quality index of the positional deviation of the recorded mark formation. In the present invention, since the positional deviation is detected using a technique that is suited to a higher density recording, the positional deviation of the recorded mark recorded on the medium with a higher density can be detected with a higher degree of accuracy. In addition, control of the recording laser pulse shape so as to reduce the transient equalization error allows a superior recording/reproduction.

While the present invention has been described based on the preferred embodiments thereof, the optical information recording/reproducing unit, method for measuring the quality of recorded mark on an optical information recording medium and the recording control method of the present invention are not limited only to the above embodiments, and a variety of modifications and alterations from the above embodiments may fall within the scope of the present invention.

This application is based upon and claims the benefit of priority from the prior Japanese Patent Application No. 2006-245236, field on Sep. 11, 2006, the entire contents of which are incorporated herein by reference.

1. An optical information recording/reproducing unit comprising:
a reproducing section that reads out a mark and a space recorded on an optical information recording medium to generate a reproduced signal waveform;
a reference-waveform generation section that generates a reference reproduced-waveform obtained by applying a specific partial response characteristic to a data train corresponding to said reproduced signal waveform;
a transient-equalization-error calculation section that calculates, as a transient equalization error, a difference between said reference reproduced-waveform and said reproduced signal waveform at a time instant of transition of said reference reproduced-waveform to a specific level-value or at a timing of transition of said reference reproduced-waveform from said specific level-value if said reference reproduced-waveform assumes said specific level-value at said time instant and said specific level-value and a level-value group at m channel clocks (m is an integer not less than one) before or after said time instant of said reference reproduced-waveform assuming said specific level-value satisfy therebetween a specific relationship that is defined in advance by a level-value corresponding to a mark or space having a specific recorded length.

2. The optical information recording/reproducing unit according to claim 1, wherein said reference-waveform generation section generates said reference reproduced-waveform by applying said specific partial response characteristic to an estimated data train estimated based on said reproduced signal waveform.

3. The optical information recording/reproducing unit according to claim 1, wherein said reference-waveform generation section reads out a recording data train recorded on the optical information recording medium from a storage unit, and generates said reference reproduced-waveform by applying said specific partial response characteristic to said recording data train.

4. The optical information recording/reproducing unit according to claim 1, wherein said reproduced signal waveform and said reference reproduced-waveform are each continuous waveform that has a level-value at each channel clock corresponding to said recorded mark or space recorded on the optical information recording medium.

5. The optical information recording/reproducing unit according to claim 1, further comprising a level-value recognition section that judges, based on a level-value of said reference reproduced-waveform or a transition of said level-value of said reference reproduced-waveform, which of said recorded mark and space or which of a front edge and a rear edge on the optical information recording medium said level-value of said reference reproduced-waveform corresponding to said time instant at which said transient equalization error is obtained corresponds, wherein said transient-equalization-error calculation section classifies said transient equalization error based on results of said recognition by said level-value discrimination section.

6. The optical information recording/reproducing unit according to claim 1, further comprising a level-group recognition section that stores therein a level transition pattern within of a plurality of channel clocks before and/or after said time instant at which said reference reproduced-waveform assumes said level-value, as a level group corresponding to a mark or space having a specific recorded length, and judges based on said level group which of a mark and a space said level-value of said time instant at which said transient equalization error is obtained corresponds,
wherein said transient-equalization-error calculation section classifies said transient equalization error based on a result of judgment by said level-group recognition section.

7. The optical information recording/reproducing unit according to claim 1, wherein said transient-equalization-error calculation section calculates at least one of a transient equalization error corresponding to a shortest mark or space on the optical information recording medium or another mark or space that is one channel clock longer than said shortest mark or space, and a transient equalization error corresponding to a front edge or rear edge of said shortest mark or space or said another mark or space that is one channel clock longer than said shortest mark or space.

8. The optical information recording/reproducing unit according to claim 1, further comprising a recording-condition control section that controls a shape of a recording laser pulse that irradiates the optical information recording medium upon data recording so that said transient equalization error decreases.

9. The optical information recording/reproducing unit according to claim 8, wherein said recording-condition control section controls said shape of said recording laser pulse by changing at least one of a starting position or ending position and a waveform shape of said recording laser pulse for each recording mark, to thereby change a position of said recorded mark or space, so that said transient equalization error decreases.

10. A method for measuring a recorded-mark quality of an optical information recording medium, that finds the recorded mark quality from a reproduced signal that is read from a mark and a space recorded on the optical information recording medium, said method comprising:
generating a reproduced signal waveform from said recorded mark and space;
generating a reference reproduced-waveform obtained by applying a specific partial response characteristic to a data train corresponding to said reproduced signal waveform;
calculating, as a transient equalization error, a difference between said reference reproduced-waveform and said reproduced signal waveform at a time instant of transition of said reference reproduced-waveform to a specific level-value or at a timing of transition of said reference reproduced-waveform from said specific level-value if said reference reproduced-waveform assumes said specific level-value at said time instant and said specific level-value and a level-value group at m channel clocks (m is an integer not less than one) before or after said time instant of said reference reproduced-waveform assuming said specific level-value satisfy therebetween a specific relationship that is defined in advance by a level-value corresponding to a mark or space having a specific recorded length.

11. The method for measuring a recorded-mark quality of an optical information recording medium according to claim 10, wherein said reference waveform generating generates said reference reproduced-waveform by applying said specific partial response characteristic to an estimated data train estimated based on said reproduced signal waveform.

12. The method for measuring a recorded-mark quality of an optical information recording medium according to claim 10, wherein said reference-waveform generating reads out a recording data train recorded on the optical information recording medium from a storage unit, and generates said reference reproduced-waveform by applying said specific partial response characteristic to said recording data train.

13. The method for measuring a recorded-mark quality of an optical information recording medium according to claim 10, wherein said reproduced signal waveform and said reference reproduced-waveform are each continuous waveform that has a level-value at each channel clock corresponding to said recorded mark or space recorded on the optical information recording medium.

14. The method for measuring a recorded-mark quality of an optical information recording medium according to claim 10, further comprising:
judging, based on a level-value of said reference reproduced-waveform or a transition of said level-value of said reference reproduced-waveform, which of said recorded mark and space or which of a front edge and a rear edge on the optical information recording medium said level-value of said reference reproduced-waveform corresponding to said time instant at which said transient equalization error is obtained corresponds, and
classifying said transient equalization error based on a result of said recognition in said judging.

15. The method for measuring a recorded-mark quality of an optical information recording medium according to claim 10, further comprising:
storing a level transition pattern within of a plurality of channel clocks before or after said time instant at which said reference reproduced-waveform assumes said level-value, and judging, based on a level group corresponding to a mark or space having a specific recorded length, which of a mark and space said level-value of said time instant at which said transient equalization error is obtained corresponds; and
classifying said transient equalization error based on a result of judgment in said judging.

16. The method for measuring a recorded-mark quality of an optical information recording medium according to claim 10, wherein said transient-equalization-error calculating calculates at least one of a transient equalization error corresponding to a shortest mark or space on the optical information recording medium or another mark or space that is one channel clock longer than said shortest mark or space, and a transient equalization error corresponding to a front edge or rear edge of said shortest mark or space or said another mark or space that is one channel clock longer than said shortest mark or space.

17. A record controlling method for an optical information recording medium in an optical information recording/reproducing unit, comprising:
generating a reproduced signal waveform from a recorded mark and space recorded on the optical information recording medium;
generating a reference reproduced-waveform obtained by applying a specific partial response characteristic to a data train corresponding to said reproduced signal waveform;
calculating, as a transient equalization error, a difference between said reference reproduced-waveform and said reproduced signal waveform at a time instant of transition of said reference reproduced-waveform to a specific level-value or at a timing of transition of said reference reproduced-waveform from said specific level-value if said reference reproduced-waveform assumes said specific level-value at said time instant and said specific level-value and a level-value group at m channel clocks (m is an integer not less than one) before or after said time instant of said reference reproduced-waveform assuming said specific level-value satisfy therebetween a specific relationship that is defined in advance by a level-value corresponding to a mark or space having a specific recorded length; and
controlling a shape of a recording laser pulse that irradiates the optical information recording medium upon data recording so that said transient equalization error decreases.

18. The record controlling method for an optical information recording medium according to claim 17, further comprising controlling said shape of said recording laser pulse by changing at least one of a starting position or ending position and a waveform shape of said recording laser pulse for each recording mark, to thereby change a position of said recorded mark or space, so that said transient equalization error decreases.
